(19) United States
(12) Patent Application Publication
(10) Pub. No.: US 2013/0125825 A1
(43) Pub. Date: May 23, 2013

(54) LOW-COST MICROBIAL HABITAT FOR WATER QUALITY ENHANCEMENT AND WAVE MITIGATION

(71) Applicants: Bruce G. Kania, Shepherd, MT (US); Frank M. Stewart, Bozeman, MT (US)

(72) Inventors: Bruce G. Kania, Shepherd, MT (US); Frank M. Stewart, Bozeman, MT (US)

(73) Assignee: Fountainhead LLC, Shepherd, MT (US)

(21) Appl. No.: 13/473,257

(22) Filed: May 16, 2012

Related U.S. Application Data
(63) Continuation-in-part of application No. 12/523,733, filed on Jul. 19, 2009, now abandoned.

(51) Int. Cl. E02B 3/04; A01K 61/00

(52) U.S. Cl. CPC E02B 3/046; A01K 61/006
USPC 119/221; 405/25

(57) ABSTRACT

A simulated coral reef comprising a polymer matrix body comprised of sheets of permeable and porous nonwoven polymer fiber matting, outwardly extending deployment connectors, and anchor connectors that connect the matrix body to an anchor assembly. A simulated coral reef comprising pieces of polymer matrix and/or permeable bag units strung together vertically by a connecting rod attached to an anchor assembly. A simulated coral reef comprising pieces of polymer matrix, permeable bag units, and surface attachment structures in which the pieces of polymer matrix and permeable bag units are attached to the surface attachment structures by a connecting cable. A simulated coral reef comprising a weed blanket fully submerged in a water body and suspended over the bottom of the water body. A simulated coral reef comprising hanging curtains suspended from asurface attachment structure. A simulated coral reef comprising sheets of permeable polymer matrix attached to a rigid metal frame.

### CROSS-REFERENCE TO RELATED APPLICATION

This application is a continuation-in-part of U.S. patent application Ser. No. 12/523,733 filed on Jul. 19, 2009, which in turns claims priority back to U.S. Patent Application No. 60/887,802, filed on Feb. 1, 2007.

### BACKGROUND OF THE INVENTION

This invention relates to low-cost, man-made structures for use in water. In particular, the invention relates to concentrated surface area, tip-resistant and wave damping floating islands and negatively buoyant structures.

Background art floating platforms are deployed for a wide variety of applications. Floating docks are used by human swimmers for resting and diving. Floating wildlife rafts are used to provide nesting and resting habitat for birds, mammals, reptiles and amphibians. Floating water treatment platforms are used to grow plants and microbes that uptake and convert water-borne contaminants such as excess nutrients and dissolved metals.

All of the structures described above have at least three major deficiencies that are overcome by the present invention. First, background art floating platforms are inherently unstable against tipping when a load is placed near their perimeter (for example, a human swimmer climbing onto a floating dock tends to tilt and submerge the edge of the platform where he is attempting to board). Second, existing-art floating platforms tend to bob and rock excessively when waves are present. Existing designs typically must be oversized to counter these motions, which increases the costs of manufacture and deployment. Third, existing designs do not integrate high levels of inexpensive scrap polymers to provide high levels of surface area for colonization by beneficial microbes, which in turn convert pollution-causing nutrients to biomass and nitrogen gas.

The background art is characterized by U.S. Pat. Nos. 5,201,136; 5,224,292; 5,528,856; 5,588,396 5,766,474; 5,980,738; 6,086,755; 6,089,191 and 6,555,219 and U.S. Patent Application Nos. 2003/0051398; 2003/0208954; 2005/0183331; the disclosures of which patents and patent applications are incorporated by reference as if fully set forth herein.

### BRIEF SUMMARY OF THE INVENTION

The purpose of the invention is to provide a high-capacity microbial habitat along with tip-resistance and wave damping for floating islands and submerged structures. Background art floating platforms rely on having a large buoyant mass to resist tipping from edge loads. In preferred embodiment, the present invention uses the weight of trapped water and/or strategically positioned negatively buoyant materials and water-produced drag to counter tipping forces. Therefore, preferred embodiments of the present invention provide enhanced stability with significantly less material mass (and therefore less material cost) than background art designs.

Wave forces have maximum energy at the surface of water bodies, and energy levels decrease with depth. Background art designs for floating platforms typically use deeply submerged floats and/or large mass to provide stability against wave motion. Preferred embodiments of the present invention utilize trapped water weight and water-produced drag to counter wave-induced motion. Therefore, preferred embodiments of the present invention can be made smaller and less costly than existing designs with comparable stability against wave-induced motion. Moreover, by having less dry weight than background art designs, preferred embodiments of the present invention are easier to construct, store, transport and deploy than background art designs.

The islands may also be used as platforms to support water aerators or water circulators. Aerators may be incorporated into the invention for increasing the dissolved oxygen concentration in the water body, which is beneficial for maintaining high growth rates of fish and aquatic insects. Aeration may also be used to increase the dissolved oxygen concentration within the submerged portions of the island body, which may be beneficial for maintaining high nutrient removal rates by microbes that colonize the interior of the island body.

Water circulators may be incorporated into the invention for improving water quality throughout the year. For example, during wintertime in cold climates, water may be circulated from the bottom of the water body to the surface. The relatively warm bottom water is useful for keeping the surface of the water body free of ice, which promotes natural transfer of oxygen and sunlight into the water body. Oxygen and sunlight are required to sustain fish and submerged plants. During summertime in warm climates, water circulation is desirable to slow the growth of free floating algae, by removing the algae from the surface layer, and circulating them to deeper regions that are cooler and have less sunlight.

In preferred embodiments, the present invention is produced in free-form shapes that are more natural in appearance than background art designs. These natural forms are advantageous at locations where aesthetic considerations are important, for example, in wildlife parks.

In preferred embodiments, in order to provide a large surface area for microbial biofilms, the island matrix is designed to have a relatively high ratio of internal surface area to bulk volume. For example, consider a cube of nonwoven polymer matrix having external dimensions of 1 foot on each side, giving a corresponding bulk volume of one cubic foot. Assume that the total surface area of the individual polymer strands within the cube is known to be about 294 square feet. Therefore the ratio of internal surface area to hulk volume is (294 ft²/1 ft³), or 294 square foot of surface area per cubic foot of bulk volume. For the purposes of this disclosure, the term “biomediation quotient” or “BMQ” is defined as the ratio of surface area to bulk volume, in which the bulk volume has dimensions of 1 foot by 1 foot by 1 inch, or 1/12 cubic foot.

In preferred embodiments, the present invention utilizes water-porous and water-permeable materials as a major component of the body of the platform. These materials are preferably assembled in the specific optimized shapes described herein. The combination of these materials and shapes of the floating island components act to minimize tipping and bobbing when the structures are subjected to temporary edge loads or to wave action.

In background art embodiments of floating islands, injected or inserted polymer foam has been utilized to provide adequate buoyancy for the floating structures. This foam is substantially non-permeable to water and eases, and takes up a portion of the internal space of the structure that would otherwise comprise a permeable volume having significant surface area for colonization by beneficial microbes. By using pieces of buoyant polymer scrap as a major component of the present invention, the requirement for including polymer foam for buoyancy is reduced or eliminated. In addition to decreasing material and fabrication costs, the reduction or elimination in buoyant foam from the structure increases the internal volume that is available for colonization by nutrient-removing microbes, thereby increasing the water-quality enhancing properties of the structure.

In a preferred embodiment, the invention is a structure (e.g., a buoyant or non-buoyant island) comprising: a body that has a center and a perimeter and that comprises a positively buoyant, water-porous and water-permeable matrix material that comprises polymer fibers or polymer shreds that are intertwined to form a randomly oriented blanket having an interior and an exterior, at least a portion of said polymer fibers or polymer shreds (e.g., that portion that, in use, is exposed to ultraviolet radiation) preferably being coated with a water-based latex binder or polyurea, said body having a thickened section at said perimeter. Preferably, said body also has a thickened section adjacent to said center. Preferably said randomly oriented blanket has surface areas that are capable of supporting colonization within said interior and along said exterior by microbes, including beneficial microbes that take up and/or convert water-borne contaminants such as excess nutrients and/or dissolved metals.

In another preferred embodiment, the invention is a buoyant island for use in a water body having a water surface, said buoyant island comprising: a platform that has a shape, a center and a perimeter and that comprises a positively buoyant, water-porous and water-permeable matrix material, said platform having a thickened section at said perimeter: wherein, in use, said platform contains a first portion of water that flows through it and a second portion of water that is trapped within said thickened section when said thickened section is lifted above said water surface. Preferably, said platform has a thickened section adjacent to said center. Preferably, said platform has surface areas that are capable of supporting colonization by beneficial microbes. Preferably, said platform has a metacenter and said shape minimizes the shift of said metacenter when tipping loads are imposed on said platform. For the purposes of this disclosure, the term “metacenter” is the point of intersection of a first vertical line that passes through the center of buoyancy of a floating body with a second vertical line that passes through the new center of buoyancy when the body is displaced.

In another preferred embodiment, the invention is a buoyant island comprising: a body that has a perimeter and that comprises a positively buoyant, water-porous and water-permeable matrix material that comprises polyester fibers that are intertwined to form a randomly oriented blanket, said polyester fibers being coated with a water-based latex binder, polyurea or polyurethane, said body having a thinned section at said perimeter and an overhanging lower lip section.

In a further preferred embodiment, the invention is a buoyant island comprising: a first portion that has a perimeter and that comprises a positively buoyant, water-porous and water-permeable matrix material that comprises polymer fibers or polymer shreds that are intertwined to form a randomly oriented blanket, said polymer fibers or polymer shreds being coated with a water-based latex binder, polyurea or polyurethane, said first portion having a thickened section at said perimeter and a center section; and a second portion that is attached to said center section of said first portion, said second portion being negatively buoyant. Preferably, said second portion comprises concrete or stone. Preferably, said positively buoyant, water-porous and water-permeable matrix material has a surface that is capable of supporting colonization by beneficial microbes.

In another preferred embodiment, the invention is an assembly comprising: a plurality of the buoyant structures or buoyant islands disclosed herein; and a plurality of attachment devices that connect each of said buoyant structures or buoyant islands to another of said buoyant structures or buoyant islands in at least two locations. Preferably, each of said attachment devices comprises a rope, a cable or a metal strip, a chain or a cord. Preferably, said water-porous and water-permeable matrix material has a surface that supports colonization by beneficial microbes.

In another preferred embodiment, the invention is a buoyant structure comprising: a body that comprises a positively buoyant, water-porous and water-permeable matrix material that comprises polymer fibers or polymer shreds that are intertwined to form a randomly oriented blanket, said body having an overhanging upper lip section, an undercut center section and an overhanging lower lip section.

In another preferred embodiment, the invention is a structure for installation in a body of water having a water surface, said structure comprising: a plurality of pieces of scrap nonwoven matrix bonded together with a bonding agent or encased in a nonwoven matrix blanket to produce a combination having elements that are operative to provide surfaces for microbial colonization. In a further preferred embodiment, the invention is a structure for installation in a body of water having a water surface, said structure comprising: a plurality of pieces of nonwoven matrix that is comprised of polyester or jute that are encased in one or more blankets of nonwoven matrix that are comprised of polyester or jute. In yet another preferred embodiment, the invention is a plurality of randomly shaped pieces of reground polymer bonded together or encased in a nonwoven matrix blanket that is operative to provide a surface for microbial colonization. Preferably, said combination is positively buoyant. Preferably, said combination is negatively buoyant.

Preferably, the structure has an interior having an interior surface area and an outer surface having an outer surface area a portion of which outer surface area is above the water surface, and said interior surface area is a multiple of said outer surface area. Preferably, the structure has an interior having an interior surface area and an outer surface having an outer surface area, and said interior surface area is greater than said outer surface area. Preferably, the structure is further comprised of polymer scrap pieces and said polymer scrap pieces are comprised of a combination of polymer fibers and a polymer foam. Preferably, the structure is further comprised of two layers of nonwoven polymer matrix, said polymer scrap pieces are arranged in a layer, and said layer of polymer scrap pieces is sandwiched between said two layers of nonwoven polymer matrix. Preferably, the structure is further comprised of multiple alternating polymer scrap piece layers and nonwoven polymer matrix layers. Preferably, said polymer scrap pieces are comprised of unsorted materials. Preferably, said polymer scrap pieces are comprised of materials having a specific gravity less than 1.0. Preferably, said polymer scrap pieces form a combined mixture and polymer scrap pieces are comprised of materials having a range of specific gravities, such that said combined mixture of polymer scrap pieces has a net positive buoyancy. Preferably, said polymer scrap pieces are comprised of materials having a specific gravity greater than 1.0. Preferably, said polymer scrap pieces form a combined mixture and said polymer pieces are comprised of materials having a range of specific gravities, such that said combined mixture of polymer scrap pieces has a net negative buoyancy.

In yet another embodiment, the invention is a structure for installation in an aqueous environment comprising: a porous containment bag; and a plurality of pieces of scrap polymer that are encased within said porous containment bag. Preferably, at least some of said pieces of scrap polymer have a specific gravity that is less than that of water, and the structure has a positive buoyancy. Preferably, at least some of said pieces of scrap polymer have a specific gravity that is greater than that of water, and the structure has a negative buoyancy.

In another preferred embodiment, the invention is a negatively buoyant structure comprising: a plurality of polymer pieces having a total surface area and a bulk volume and having a total surface area to bulk volume ratio of at least 200 that, together, are operative to provide biomimetic replication of a natural coral formation in saltwater or a stone formation in freshwater, having cavities and crevices for use by aquatic animal life for hiding, resting or feeding. In another preferred embodiment, the invention is a permeable and negatively buoyant structure for installation in a water body having a bottom, said structure comprising: a plurality of polymer pieces having a total surface area and a bulk volume and having a total surface area to a bulk volume ratio of at least 200, that, together, are operative to anchor a floating island or to tether another floating object to the bottom, thereby allowing the anchoring of a floating object when the bottom of the water body is soft or otherwise unsuitable for conventional anchors, the permeability of said structure providing additional drags when said object is pulled through the water body, thereby enhancing the anchoring properties of said structure.

In another preferred embodiment, the invention is a buoyant structure comprising: a body that is selected from the group consisting of: (1) a first portion having a periphery and comprising a positively buoyant, water-porous and water-permeable matrix material, and a second portion comprising a pontoon member that is disposed at said periphery of said first portion, (2) a first portion comprising a platform having a periphery and a center section that is comprised of a positively buoyant, water-porous and water-permeable matrix material, a second portion comprising a pontoon member that is disposed at said periphery of said first portion, and a third portion that is attached to said center section, (3) a first portion having a periphery and comprising a platform having a center section that is comprised of a positively buoyant, water-porous and water-permeable matrix material, a second portion that is disposed at said periphery of said first portion, said second portion being thinner in cross section than said center section, and a third portion that is attached to said center section, (4) a first portion having a periphery and comprising a platform having a center section that is comprised of a positively buoyant, water-porous and water-permeable matrix material, a second portion comprising a pontoon member that is disposed at said periphery of said first portion, and a third portion that is attached to said center section, said third portion being negatively buoyant, (5) a first discrete portion comprising a positively buoyant, water-porous and water-permeable matrix material, and a second discrete portion comprising said positively buoyant, water-porous and water-permeable matrix material, said discrete portions not being in contact with one another, and (6) a middle portion that is comprised of a positively buoyant, water-porous and water-permeable matrix material, said middle portion having a periphery, a top portion that is comprised of said positively buoyant, water-porous and water-permeable matrix material, said top portion extending radially beyond said periphery, and a bottom portion that is comprised of said positively buoyant, water-porous and water-permeable matrix material, said bottom portion extending radially beyond said periphery; and a plurality of attachment means that connect said portions to one another in at least two places; wherein, in use, each of said portions contains a first quantity of water that flows through it and/or a second quantity of water that is trapped within it when it is lifted above said water surface. In this embodiment, the “positively buoyant, water-porous and water-permeable matrix material” may be positively buoyant due to the buoyancy of the nonwoven polymer fibers or polymer shreds, and/or it may be positively buoyant due to buoyant polymer foam that is added to said matrix.

In another preferred embodiment, the invention is a floating island for installation in a water body, said floating island comprising: three first layers, each first layer comprising a nonwoven polymer matrix; and two second layers, each second layer comprising a plurality of scrap polymer pieces; wherein each of said second layers is disposed between two of said first layers. Preferably, the floating island further comprises: an inlet pipe that is extendable into the water body; a water pump that is operative to move water into said inlet pipe; a solar collector that is operative to supply power to said water pump; and a discharge line for distributing said water over the uppermost of said first layers.

In another preferred embodiment, the invention is a simulated coral reef comprising: a plurality of scrap polymer pieces that are bonded together to produce a non-buoyant body; and an injection system for injecting water and/or air into said non-buoyant body. Preferably, said non-buoyant body has cavities. Preferably, the simulated coral reef further comprises a bag of dry cement that is disposed in one of said cavities.

In another preferred embodiment, the invention is a polymer scrap structure comprising: a plurality of scrap polymer pieces that are bonded together with polyurea or polyethylene to form a body having cavities; and a gas-impermeable top coat comprised of polyurea or polyethylene. In another preferred embodiment, the invention is a floating island comprising: a sheet of nonwoven matrix having a top side and a bottom side; a first plurality of scrap polymer pieces that are attached to said top side to produce a growth platform, said growth platform comprising a perimeter lip and having capillary tubes that are filled with a hydrophilic material; a second plurality of scrap polymer pieces that are attached to said bottom side; and a plant growth medium that is disposed on said growth platform, said plant growth medium being in communication with said hydrophilic material in said capillary tubes. Preferably, the floating island further comprises: matrix scrap pieces that are disposed within said second plurality of scrap polymer pieces.

In another preferred embodiment, the invention is a floating island comprising: a single bottom layer that is comprised of nonwoven matrix; a middle portion that is comprised of scrap nonwoven matrix or another polymer material; and a top blanket of sod, sod impregnated jute or sod impregnated polymer blanket. Preferably, said nonwoven matrix is comprised of a natural nonwoven material. Preferably, said natural nonwoven material is selected from the group consisting of coir, jute, hemp and cotton.

In another embodiment, the invention is an island that is manufactured in a “sandwich” configuration, using relatively thin layers of nonwoven matrix that are separated by relatively thick layers of polymer strands, polymer chips or polymer shreds. The nonwoven matrix may be comprised of 1-inch thick nonwoven polyester, polypropylene, or polyethylene fibers. Alternately, sheets of extruded polymer foam may be used in place of nonwoven matrix. The pore spaces within the sheets of extruded foam may be closed-cell, open-cell, or a combination of closed and open cell foam. The polymer pieces may be comprised of recycled scrap materials. Examples of suitable scrap materials include HDPE (high density polyethylene) milk jugs and PETE (polyethylene terephthalate) soft drink bottles. Polymer jugs and bottles are commonly recycled by grinding and passing the resulting pieces through a ½-inch screen, whereby the maximum dimensions of the resulting scrap pieces are approximately ½-inch wide, ½-inch long, and the thickness of the original polymer container wall. The shapes of the scrap pieces may optionally be optimized for such applications by cutting the pieces into custom shapes and sizes, such as relatively lone, narrow strips that may be mechanically intertwined and/or bonded with a latex, polyurea or polyurethane coating to form a blanket having a large available internal surface area for colonization by beneficial microbes. One example of more preferred strip dimensions would be 1/16-inch wide, 3 inches long, and having a thickness of the original wall thickness of the recycled polymer container from which the scrap was produced. Optionally, the strips may be intentionally formed using cutting blades that produce jagged edges on the strips. These jagged edges may help the strips to lock together when intertwined into a nonwoven blanket. The jagged edges may also maximize available surface area for microbial colonization on each strip. These jagged-edge strips biomimic the roots and other organic debris that comprise some natural floating islands.

In any of the embodiments described above, the floating island or other structure may be fabricated from nonwoven polymer matrix (or foam sheets) and pieces of polymer strands, chips or shreds, and a coating that is applied only to the outside surface of the floating island or other structure. Said coating may be comprised of polyurea, polyurethane, latex, rubber, or any other similar material that protects the polymer material from ultraviolet (UV) light degradation, while bonding the materials together. In these embodiments, the size of the scrap pieces and the size of the openings within the nonwoven matrix (or foam sheets) are chosen so as to be compatible, in order to produce a structure in which the internal polymer pieces cannot escape from the structure through the openings in the nonwoven matrix (or foam sheets), yet water and gases are able to pass through the structure.

Shredded pieces of automobile tires or other objects comprised from natural or synthetic rubber may be used as polymer shreds in both the floating and non-floating embodiments. Although junk automobile tires have been bundled together in the background art to create artificial reefs in previous inventions, the present invention preferably utilizes shredded pieces rather than whole tires. The shredded pieces provide much greater surface area per unit mass than whole tires, making the pieces more suitable for colonization by beneficial microbes. The structures may optionally be used as support bases for aerators or water circulators, which are used to enhance water quality.

In another embodiment, the entire structure is comprised of shredded polymer pieces that may be manufactured from recycled scrap. In this embodiment, the polymer pieces may be bonded together with a spray coating of polyurea or polyurethane. Alternately, the shredded pieces may be contained within a permeable bag comprised of polymer, nylon, or other suitably porous material. On example of a suitable material is extruded polyethylene mesh having a screen opening size that prevents the escape of the shredded polymer pieces contained within a bag that is made from the mesh material. One such mesh material is available from McMaster-Carr of Los Angeles, Calif. (part number 9314T29). This embodiment may be used as a conventional, buoyant floating island.

Alternately, all embodiments may be manufactured so as to be negatively buoyant. In the negatively-buoyant configuration, the structure resembles a simulated coral reef, which rests on the bottom of the water body. The simulated coral reef may be injected with air and/or water to promote microbial removal of dissolved nutrients, and to supply oxygen to fish and other aquatic animals that reside around and within the structure. In a similar embodiment that is optimized for aquaculture, nutrients, organic carbon, and/or other materials may be added to the injection water and injected into the structure in order to promote the growth of plankton and microbes, thereby stimulating the food chain, and resulting in increased production of fish or other commercial aquatic products.

For the embodiments that comprise polymer scrap, chips or shreds, the cost of the polymer materials may be minimized by utilizing a blend of various polymer scraps that are available at relatively cost from recyclers. These unsorted blends may be comprised of any combination of polymer materials. Unsorted polymer scrap blends are commonly available at lower cost than sorted scrap, because they currently have limited market potential compared to sorted polymers.

When scrap blends are used in preferred positively buoyant embodiments of the present invention, it may be advantageous to utilize partially sorted blends that are comprised solely or primarily of materials having a specific gravity less than 1.0. These scrap blends have positive net buoyancy, and are available at lower cost than scrap that has been sorted to comprise a single polymer material.

The size and shape of the polymer scrap chips may be varied in the recycling process so as to provide an optimum combination of advantageous qualities. Advantageous qualities may include greater surface area for microbial colonization, increased porosity and stiffness for plant root support, water permeability, and the ability to be contained easily within a matrix “sandwich” without escaping.

For a given mass of polymer scrap, the surface area available for microbial colonization generally increases as the size of the individual chip size decreases (i.e., the ratio of surface area to volume becomes greater as the chip size becomes smaller). Also, chips made from thin stock (such as scrap milk jugs) generally have more surface area per unit mass than chips produced from thick stock (such as automobile bumpers). Therefore, in applications of the present invention in which high internal surface area is important, small or thin chips maybe preferred over large or thick chips.

The unit surface area of one sample of blended scrap was measured. This material was a low-cost blend of polyethylene and polypropylene that was run through a grinder with a one-half inch screen. Based on measurements of representative chips, the estimated surface area for these chips was 32.2 square feet of surface area per cubic foot of chips, or 1.2 square feet of surface area per pound of chips. This is equivalent to 2.7 square feet for a volume that is 1 square foot by 1 inch thick, or roughly one-tenth the BMQ of the matrix. If the chips were run through a one-quarter-inch screen, the approximate surface area of these chips would be 5.4 square feet for a volume that is one square foot by one inch thick, or roughly one-fifth the BMQ of the matrix.

The present invention further comprises a simulated coral reef comprising: a polymer matrix body comprised of one or more sheets of permeable and porous nonwoven polymer fiber matting; one or more deployment connectors extending outward from the polymer matrix body; and one or more anchor connectors, each of which connects the matrix body to an anchor assembly. In a preferred embodiment, each anchor assembly is comprised of a deadweight and an anchor terminal. The invention preferably further comprises a flexible connection joint between each anchor connector and anchor terminal.

In a preferred embodiment, the one or more sheets of permeable and porous nonwoven polymer fiber matting are injected with expanding closed-cell polymer foam. Preferably, the invention further comprises at least one connecting rod that passes through the matrix body and connects a deployment connector to an anchor connector. The matrix body preferably comprises one or more holes configured to provide increased microbial surface area in contact with moving water and to provide cover habitat for aquatic animals.

In one embodiment, the invention further comprises an air bubbler situated beneath the matrix body. Preferably, the matrix body is comprised of polymer fibers reinforced with-latex binder. Alternately, the matrix body is comprised of recycled carpet fibers bonded into a permeable mat. In a preferred embodiment, the matrix body comprises internal pore spaces between fibers, and the matrix body is sufficiently rigid so that the internal pore spaces between the fibers remain open when exposed to water current forces.

The invention is also a simulated coral reef comprising one or more pieces of polymer matrix, wherein the one or more pieces of polymer matrix are strung together vertically by a connecting rod that passes through the one or more pieces of polymer matrix; and wherein the connecting rod comprises a lower end, and the lower end of the connecting rod is attached to an anchor assembly. Alternately, the invention is a simulated coral reef comprising one or more permeable bag units, wherein the one or more permeable bag units are strung together vertically by a connecting rod that passes through the one or more permeable bag units; and wherein the connecting rod comprises a lower end, and the lower end of the connecting rod is attached to an anchor assembly. In yet another alternate embodiment, the invention is a simulated coral reef comprising one or more pieces of polymer matrix and one or more permeable bag units, wherein the one or more pieces of polymer matrix and the one or more permeable bag units are strung together vertically by a connecting rod that passes through the one or more pieces of polymer matrix and the one or more permeable bag units; and wherein the connecting rod comprises a lower end, and the lower end of the connecting rod is attached to an anchor assembly.

In a preferred embodiment, each piece of polymer matrix is comprised of polyester fibers reinforced with latex binder. Alternately, each piece of polymer matrix is comprised of recycled carpet fibers bonded into a permeable mat. In a preferred embodiment, each permeable bag unit is comprised of a containment bag made of netting tilled with scrap pieces of polymer matrix. Alternately, each permeable bag unit is comprised of a containment bag made of netting filled with loose polymer fibers. In yet another alternate embodiment, each permeable bag unit is comprised of a containment bag made of netting filled with a combination of scrap matrix and loose fibers.

In a preferred embodiment, each piece of polymer matrix is further comprised of buoyant polymer foam. Preferably, each permeable bag unit is further comprised of buoyant polymer foam. In one embodiment, the buoyant polymer foam is uncured thermoset foaming resin. In another embodiment, the buoyant polymer foam is uncured foaming thermoplastic foaming resin that is injected into the one or more pieces of polymer matrix for curing. In another embodiment, the buoyant polymer foam is uncured thermoplastic foaming resin that is injected into the one or more permeable bag units for curing. In another embodiment, the buoyant polymer foam is preformed pieces of thermoset foam that are manufactured into the one or more pieces of polymer matrix. In yet another embodiment, the buoyant polymer foam is preformed pieces of thermoset foam that are manufactured into the one or more permeable bag units.

In an embodiment, the one or more pieces of polymer matrix further comprise a negative buoyancy material. In another embodiment, the one or more permeable bag units further comprise a negative buoyancy material.

The invention is also a simulated coral reef comprising: one or more pieces of polymer matrix; one or more permeable bag units; and one or more surface attachment structures: wherein the one or more pieces of polymer matrix and the one or more permeable bag units are attached to the one or more surface attachment structures by a connecting cable. In a preferred embodiment, the one or more surface attachment structures are floating objects that are anchored to a water body bottom by a connecting rod.

In one embodiment, the one or more pieces of polymer matrix comprise polymer foam. In another embodiment, the one or more permeable bag units comprise polymer foam. In one embodiment, the one or more pieces of polymer matrix comprise a negative buoyancy material. In another embodiment, the one or more permeable bag units comprise a negative buoyancy material.

The invention is also a simulated coral reef comprising a weed blanket that is fully submerged in a water body with a bottom but suspended over the bottom of the water body. In a preferred embodiment, the weed blanket is comprised of polymer fibers between two layers of permeable fabric. Preferably, the weed blanket is comprised of sheets of polymer matrix material. In one embodiment, the weed blanket is positively buoyant. In an alternate embodiment, the weed blanket is negatively buoyant. In another alternate embodiment, the weed blanket is neutrally buoyant.

In a preferred embodiment, the invention further comprises anchor weights that are situated on top of the weed blanket. Preferably, the fibers are segmented into compartments to prevent migration and clumping of the fibers. In an alternate embodiment, the weed blanket has a perimeter, and the invention further comprises linear anchor weights that are situated along at least a portion of the perimeter of the weed blanket.

The invention is also a simulated coral reef comprising hanging curtains suspended from at least one surface attachment structure, wherein the hanging curtains are comprised of polymer fibers between sheets of permeable fabric with quilted partitions. The invention is also a simulated coral reef comprising hanging curtains suspended from at least one surface attachment structure, wherein the hanging curtains are comprised of one or more sheets of nonwoven polymer matrix.

The invention is also a simulated coral reef comprising one or more sheets of permeable polymer matrix attached to a rigid metal frame and situated within a water body with a water direction that moves from front to back of the simulated coral reef. In a preferred embodiment, the sheets of permeable matrix are sloped upward from front to back of the simulated coral reef. Preferably, the invention further comprises a polymer net bag placed over a front edge of the structure. The one or more sheets of permeable polymer matrix preferably comprise one or more viewing ports in the form of cutouts in the matrix.

The invention is also a simulated coral reef comprising two or more sheets of polymer matrix bonded together with foam adhesive and further comprising one or more passageways for allowing fish and fish food to pass through the matrix. In a preferred embodiment, the invention further comprises one or more rock-filled cavities. Preferably, the invention further comprises one or more anchor stakes. Alternately, the invention further comprises one or more anchor weights.

The invention is also a simulated coral reef comprising a single continuous tube of netting divided into permeable bag units, wherein the single continuous tube of netting is situated above a water bottom body and held in position by an anchor assembly. The invention is also a simulated coral reef comprising a single continuous tube of netting divided into permeable bag units, wherein the single continuous tube of netting is attached to a floating structure. In a preferred embodiment, the permeable bag units are filled with scrap pieces of polymer matrix. In an alternate embodiment, the permeable bag units are filled with loose polymer fibers. In another alternate embodiment, the permeable bag units are filled with a combination of scrap pieces of polymer matrix and loose polymer fibers.

In a preferred embodiment, the tube of netting is comprised of nylon fish netting. In one embodiment, the invention further comprises a negative buoyancy component positioned within at least one of the permeable bag units. In another embodiment, the invention further comprises a negative buoyancy component attached to a bottom end of the continuous tube of netting. Preferably, the invention further comprises

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE DRAWINGS

The features of the invention will be better understood by reference to the accompanying drawings which illustrate presently preferred embodiments of the invention. In the drawings:

FIG. 1 is a side (elevation) cross-section view of a preferred embodiment of a floating island in accordance with the invention.

FIG. 2 is another side cross-section view of the embodiment of FIG. 1.

FIG. 3 is a side cross-section view of another preferred embodiment of the invention, which has a thickened center section.

FIG. 4 is a schematic side elevation view of another preferred embodiment of the invention.

FIG. 5 is a schematic side cross-section view of another preferred embodiment of the invention.

FIG. 6 is a side cross-section view of yet another preferred embodiment of the invention.

FIG. 7 is a top plan view of another preferred embodiment of the invention.

FIG. 8 is a side cross-section view of yet another preferred embodiment of the invention.

FIG. 9 is a side cross-section view of a sandwich configuration buoyant island in accordance with another preferred embodiment of the invention.

FIG. 10 is a side cross-section view of a simulated coral reef structure in accordance with another preferred embodiment of the invention.

FIG. 11 is a side cross-section view of a polymer scrap floating island in accordance with another preferred embodiment of the invention.

FIG. 12 is a side cross-section view of an island comprising polymer scrap and growth medium in accordance with another preferred embodiment of the invention.

FIG. 13 is a side cross-section view of a three-layer island with overhanging top blanket.

FIG. 14 is a perspective view of a positively buoyant simulated coral structure suspended above the bottom of a water body.

FIG. 15 is a perspective view of a buoyant simulated coral structure that is fabricated from one or more pieces of polymer matrix and/or one or more permeable bag units.

FIG. 16 is a side view of a simulated coral structure that is connected between two surface attachment units.

FIG. 17 is a perspective view of a weed blanket suspended over the bottom of a water body by perimeter anchors.

FIG. 18 is a magnified cross-section view of the weed blanket shown in FIG. 17.

FIG. 19 is a perspective view of a weed blanket that is suspended over the bottom of a water body by linear anchor weights along two edges of the weed blanket.

FIG. 20 is a perspective view of hanging curtain structures that are suspended from floating attachment structures.

FIG. 21 is a perspective view of a frame-and-matrix fish shelter for use in moving water.

FIG. 22 is a perspective view of a frameless fish shelter designed for use in moving water.

FIG. 23 is a detail partial view of the first embodiment modified to comprise an internal volume for optional additives.

FIG. 24 is a partial view of the second embodiment modified for the addition of supplemental additives.

FIG. 25 is a detail of the fourth embodiment modified to accept supplemental additives.

FIG. 26 is a perspective view of the “sausage bag” embodiment, which is a modified version of the second embodiment.

FIG. 27 is a perspective view of the “sausage bag” embodiment shown attached to a floating structure.

### REFERENCE NUMBERS

1 Floating island, buoyant island, buoyant structure, structure, platform

2 Body of water, water body

3 Porous and permeable matrix material, nonwoven matrix, matrix

4 Portion of island above waterline

5 Portion of island below waterline

6 Vertical load

7 Portion of island depressed by vertical load, first portion

8 Downward directional arrow, downward arrow

9 Portion of island lifted by vertical load, second portion, uplifted portion

10 Upward directional arrow, upward arrow

11 Thickened center section, center section

12 Arrows depicting up-and-down wave forces, up and down arrows

13 Arrows depicting rocking motion wave forces, rocking arrows

14 Thin edge zone

15 Negatively buoyant region

16 Attachment devices

17 Overhanging top lip section

18 Undercut center section

19 Overhanging lower lip section, overhanging lip feature

20 Habitat area, habitat feature

21 Fish

22 Sandwich configuration island, sandwich island

23 Scrap polymer pieces, scrap pieces

24 Solar panel

25 Water pump

26 Inlet pipe

27 Discharge lines

28 Simulated coral reef structure

29 Injection system

30 Cavities

31 Polymer scrap island, polymer scrap structure

32 Impermeable top coat

33 Growth medium

34 Capillary tubes

35 Perimeter lip

36 Scrap matrix pieces

40 Intake arrows

41 Bottom layer

42 Middle portion

43 Top blanket

44 Polyurethane foam

101 Buoyant simulated coral structure

102 Lake bottom

103 Anchor assembly

104 Polymer matrix body

105 Deployment connector

106 Anchor connector

107 Holes

108 Air bubbler

109 Deadweight

110 Anchor terminal

111 Connecting rod

112 Pieces of polymer matrix

113 Permeable bag units

114 Surface attachment structure

115 Connecting cable

116 Weed blanket

117 Anchor weights

118 Submerged aquatic plants

119 Polymer fibers

120 Permeable fabric

121 Polymer thread or rope

122 Linear anchor weight

123 Hanging curtain

124 Frame and matrix fish shelter

125 Sheets of polymer matrix

126 Metal frame

127 Rock-filled polymer net bag

128 Frameless fish shelter

129 Rock-filled cavity

130 Passageway

131 First matrix layer

132 Second matrix layer

133 Edge matrix layer

134 Supplemental additives

135 Resealable flap opening

136 Hollow portion

137 Reclosable door

138 Quilted unit

139 Continuous tube of netting

140 Sausage bag

141 Polymer rope, polymer webbing, plastic ties

### DETAILED DESCRIPTION OF THE INVENTION

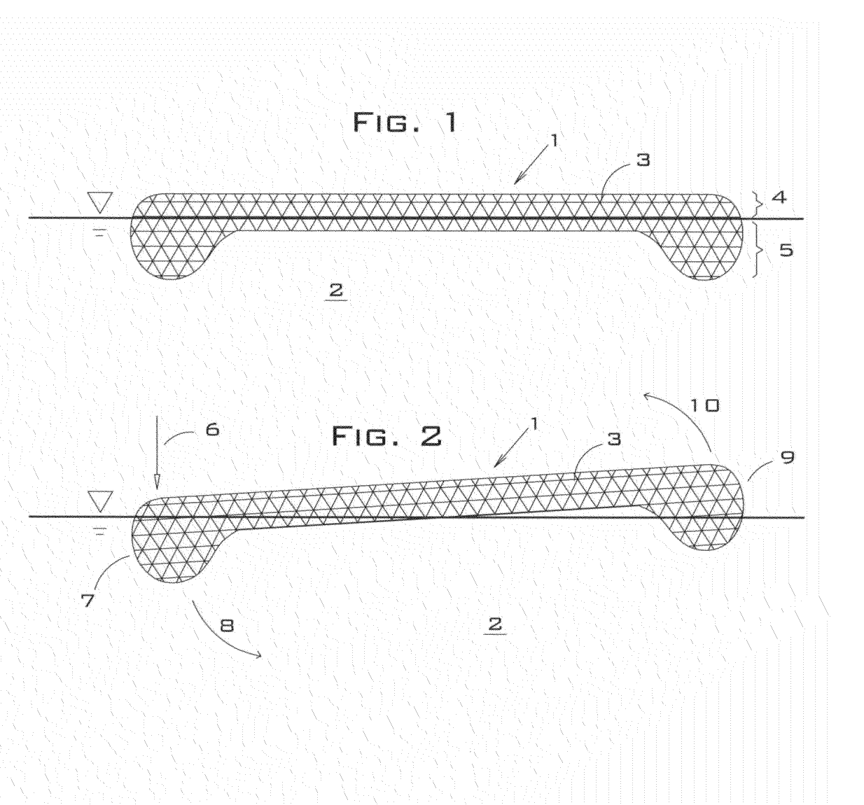

Referring to FIG. 1, a preferred embodiment of floating island 1 is shown floating in a normal position within a body of water 2. In this embodiment, structure 1 is substantially round in shape when viewed in plan from above. This embodiment is referred to herein as the “pontoon design,” from the thickened, pontoon-like shape (in cross section) of the section of the body of floating island 1 at its perimeter. FIG. 2 is a side cross-section view of the same embodiment, shown when the invention is being subjected to a temporary perimeter load.

As shown in FIG. 1, floating island 1 is comprised of a water-porous and water-permeable matrix material 3. Portion 4 of floating island 1 is above water line, and portion 5 is below the waterline. The pore spaces of matrix 3 within the above-waterline portion 4 are filled with air, and the pore spaces of matrix 3 that are within the below-waterline portion 5 are filled with water. In this embodiment, structure 1 floats because the fibers comprising matrix 3 have a density that is less than the density of water. Alternately, supplemental buoyancy may be provided by providing injected polymer foam floatation (not shown). Matrix 3 may be comprised of polymers or natural materials.

In a preferred embodiment, matrix 3 is comprised of polyester fibers that are intertwined to form a randomly oriented web or “blanket,” preferably with a standard thickness and width. While smaller islands may be made of a single piece and thickness of matrix, the dimensions of a larger island body are set by attaching multiple pieces of matrix 3 side-by-side and/or vertically. In one preferred embodiment, matrix 3 is comprised of 200-denier polyester Fibers that are intertwined to form a blanket approximately 1¾ inch thick by 56 inches wide.

Preferably, matrix 3 is produced in a continuous strip and is cut into portions having lengths of approximately 90 feet for shipping. The nominal weight of the blanket is preferably 41 ounces per square yard. The nominal weight of the polyester fibers within the blanket is preferably 26 ounces per square yard. A water-based latex binder is preferably baked onto the fibers to increase the stiffness and durability of the blanket. The characteristics of matrix 3 can he adjusted by varying the construction materials and manufacturing process. For example, the diameter of the fibers may be varied from approximately 6 to 300 denier. Coarse fibers result in a relatively stiff matrix with relatively small surface area for colonizing microbes, and fine fibers result in a relatively flexible matrix with a relatively large surface area for colonizing microbes. The latex binder can be applied relatively lightly or relatively heavily to vary the durability and weight of the matrix, and dye or pigment can be added to the binder to produce a specific color of matrix.

The thickness of the blanket can be adjusted from approximately ¼-inch to 2 inches using conventional manufacturing techniques. It is anticipated that thicker blankets will be produced in the future, and these thicker blankets (for example, 3 to 12 inches) will be used as island body material when they become available. The blankets with integral latex binder may be purchased as a manufactured item. One manufacturer of suitable matrix material is Americo Manufacturing Company, Inc. of Acworth, Ga. Alternately, matrix 3 may be comprised of natural nonwoven materials such as coir, jute, hemp or cotton.

Referring to FIG. 2, the position of floating island 1 is illustrated just after a significant vertical load 6 has been applied to an edge of structure 1. Load 6 produces a tipping moment on island 1. The tipping moment causes first portion 7 of island 1 to move in the direction of downward arrow 8, deeper into water body 2. Similarly, the tipping moment causes second portion 9 of island 1 to move in the direction of upward arrow 10, rising above waterline.

In a preferred embodiment, floating island 1 comprises three features that resist the tipping moment produced by vertical load 6. First, the extra weight of matrix 3 due to the thickened perimeter of uplifted portion 9 provides a resisting moment arm force that is greater than would be provided by a structure without a thickened perimeter. Second, water that is trapped within uplifted portion 9 takes some time to drain from permeable matrix 3 due to the surface tension between the water and the fibers of matrix 3. The trapped water adds extra weight to uplifted portion 9 that is raised above waterline, and this extra weight increases the resisting moment arm. Third, the water-porous and water-permeable nature of matrix 3 causes water to flow through matrix 3 whenever floating island 1 is moved through water body 2. The water movement through the matrix fibers produces drag, forces that resist the movement of floating island 1 within water body 2. In FIG. 2, first portion 7 of island 1 that is being moved in the direction of downward arrow 8 encounters significant drag as it is submerged in water body 2, thereby resisting rotational movement due to the tipping moment. The buoyancy of first portion 7 that is being submerged also resists rotational movement.

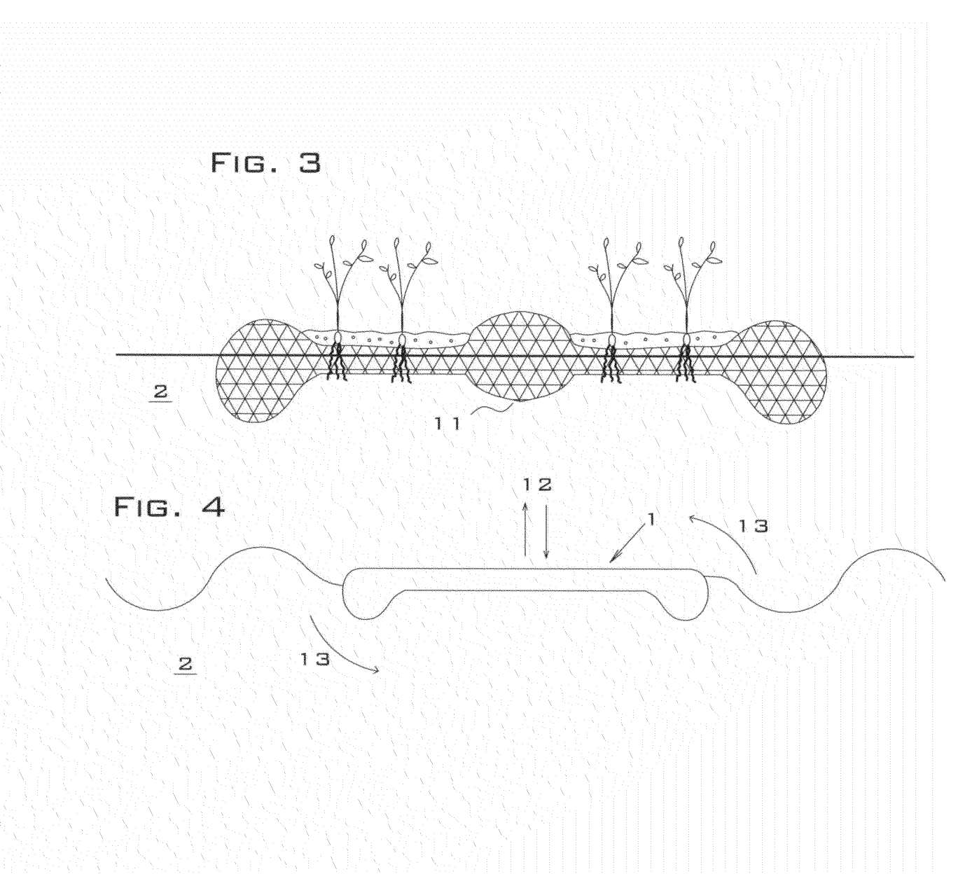

Referring to FIG. 3, another preferred embodiment of the invention having thickened center section 11 is presented. This embodiment has the same three anti-tipping features described for the embodiment of FIGS. 1 and 2. In addition, center section 11 of the embodiment shown in FIG. 3 provides additional moment arm and water drag to resist tipping due to edge loads.

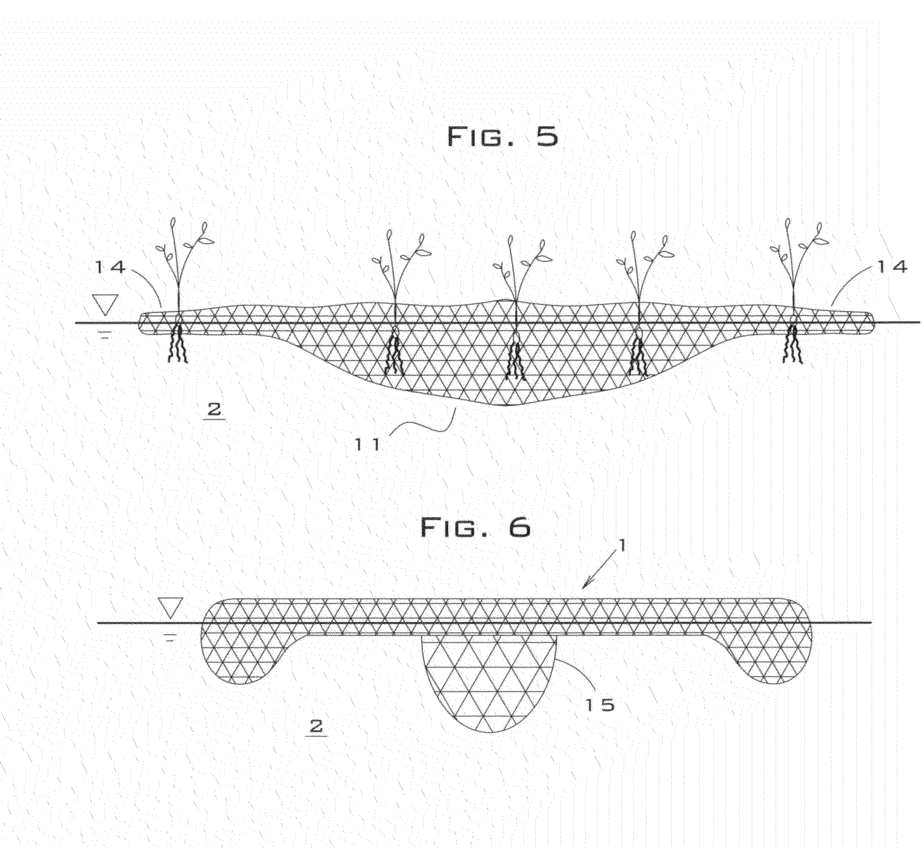

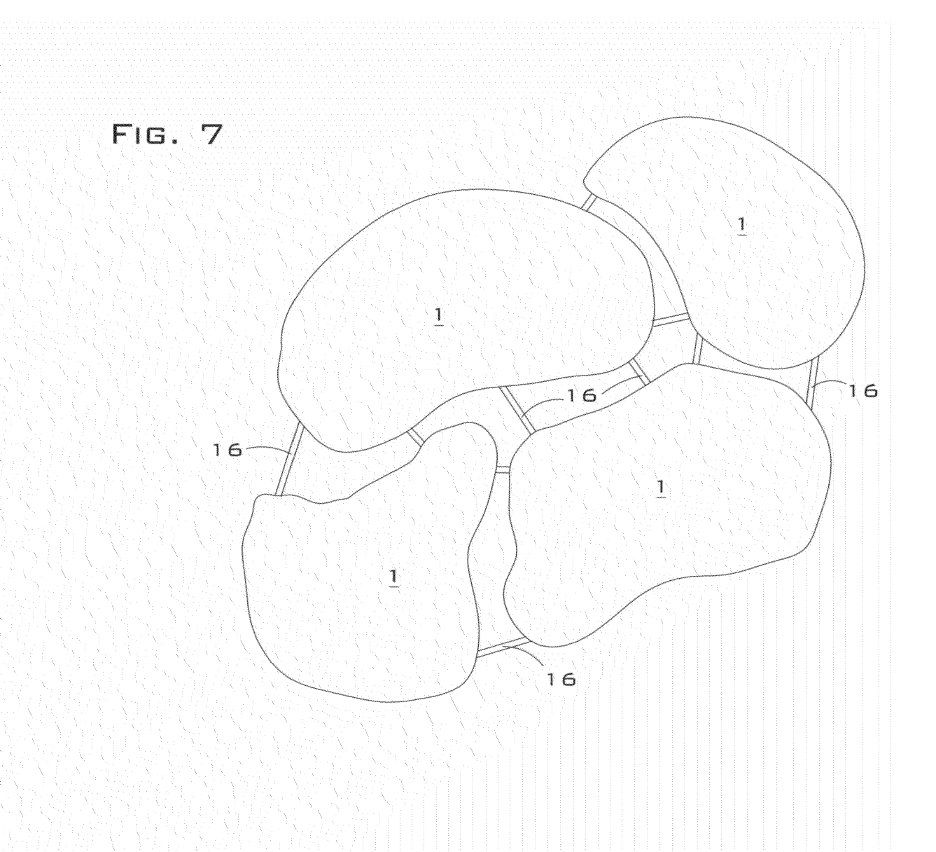

Preferred embodiments of the invention are also resistant to movements due to wave action. Referring to FIG. 4, waves produce both up-and-down forces (shown by arrows 12) and rocking forces (shown by rocking arrows 13) on floating island 1. Both of these forces are resisted by floating island 1. The weight of trapped water in portions of floating island 1 that are lifted above waterline resists such upward motion, while drag forces produced by water flowing through the matrix 3 of moving, submerged portions of the floating islands resist both vertical and rocking motion induced by wave forces. In addition, as wave water is forced into and through the porous and permeable matrix 3 of floating island 1, wave energy is dissipated and reflected, thereby reducing the magnitude of the wave height and energy.

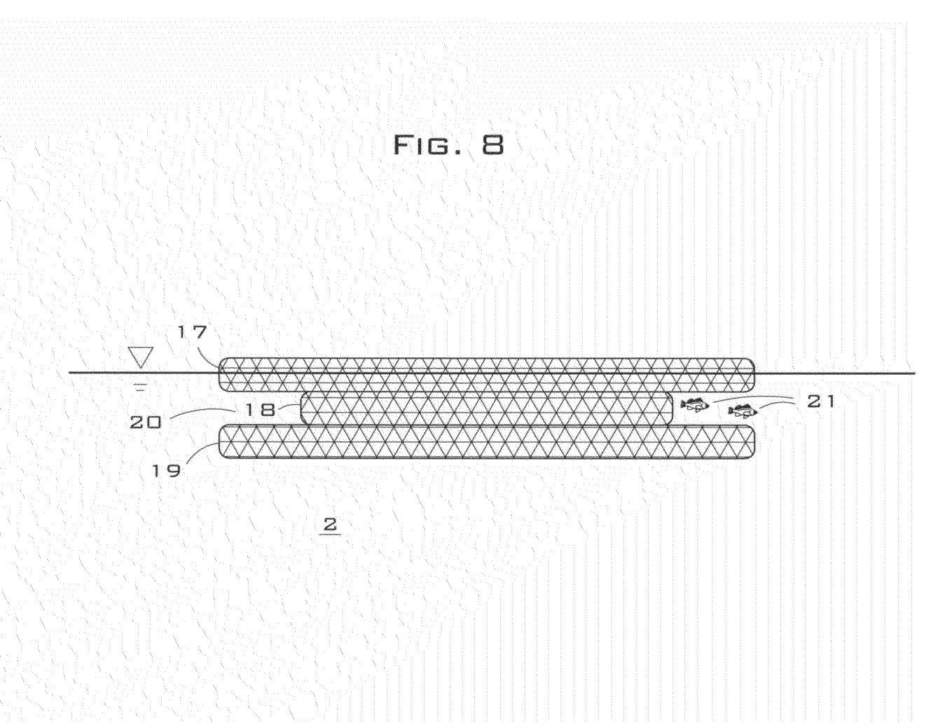

Referring to FIG. 5, another preferred embodiment of the invention is presented. This embodiment mimics the shape of some natural islands that were investigated in Michigan and Wisconsin by the applicants during 2004. In this embodiment, large, water-saturated center section 11 provides a heavy, low center of gravity that resists vertical motion, while thin edge zones 14 provides wave-damping action due to their relatively large-surface areas, which serves as a breakwater against incident waves.

Referring to FIG. 6, yet another preferred embodiment of the invention is presented. This embodiment incorporates a negatively buoyant region 15 within the body of floating island 1. Negatively buoyant region 15 may be comprised of permeable and porous matrix material that is negatively buoyant. Nonwoven polyester is an example of a preferred negatively buoyant matrix material. Alternately, negatively buoyant region 15 may be comprised of negatively buoyant material such as concrete or stone that is placed within the matrix material making up the body of floating island 1. Negatively buoyant region 15 serves as a keel to lower the center of gravity of floating island 1. This keel effect, in combination with the porous and permeable matrix comprising region 15, further enhances island stability.

Referring to FIG. 7, another preferred embodiment of the invention is presented. In this embodiment, outrigger floating islands 1 are used to provide an anti-tipping feature. As shown in the drawing, separate outrigger floating islands 1, ideally of the same porous and permeable matrix construction, are connected to one other with attachment devices 16. This arrangement allows for designable levels of water-produced drag. In a preferred embodiment, such floating islands 1 are joined in at least two locations, preferably towards the opposing ends of the smaller floating island 1. In the event floating islands 1 of similar size are joined in this fashion, preferred attachment points would again tend to correspond with opposing ends of each floating island 1, to allow for utilization of attachment devices 16 to provide a physical barrier to island tipping. Attachment devices 16 may be comprised of any suitably strong and durable material such as rope, cable, or metal strips.

Referring to FIG. 8, yet another preferred embodiment of the invention is presented. In this embodiment, an overhanging lip feature 19, preferably fabricated from the same water-porous and water-permeable matrix material, is incorporated into, preferably, the lowest portion of an island. Besides adding a designable level of tip resisting, drag, such a horizontal yo-yo shaped design provides additional underwater habitat feature 20. As shown in FIG. 8, this embodiment comprises overhanging upper lip section 17, undercut center section 18, and overhanging lower lip section 19. Habitat area 20 that is produced by the undercut center section 18 may be utilized by fish 21 and other wildlife species.

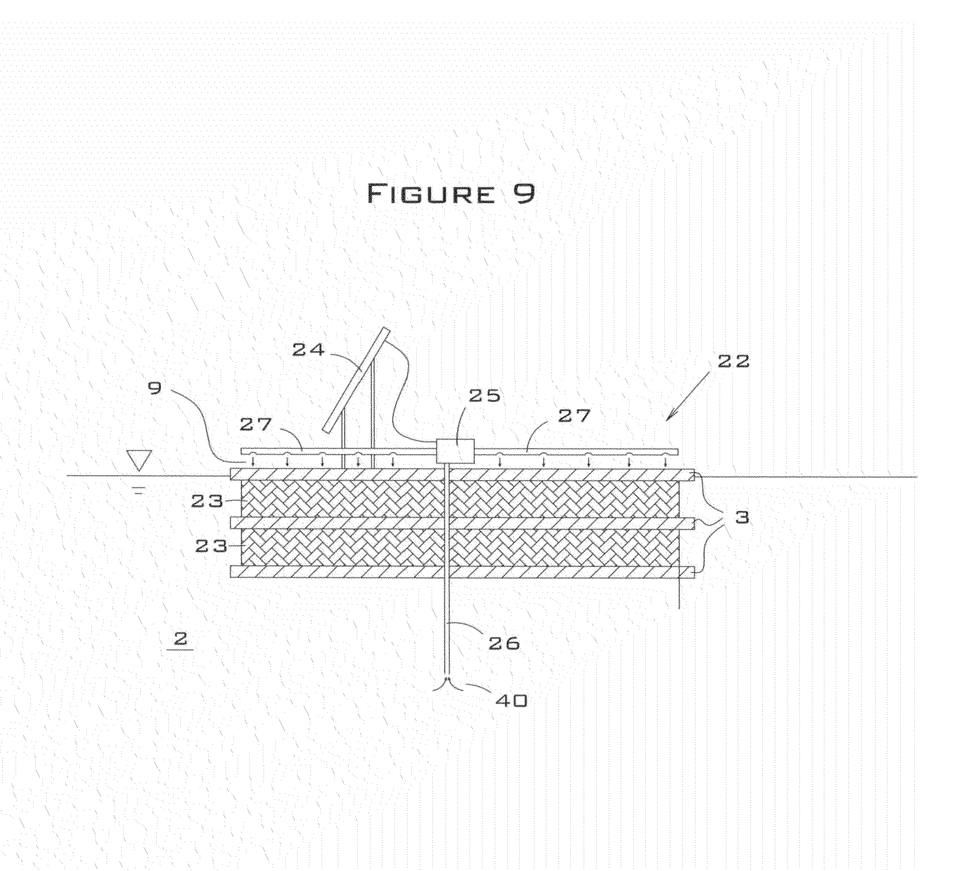

Referring to FIG. 9, a sandwich configuration island 22 is illustrated that is preferably comprised of three layers of nonwoven polymer matrix 3 and two layers of recycled scrap polymer pieces 23 although other numbers of layers may be used. Also shown are optional water circulation components that consist of solar panel 24, water pump 25, inlet pipe 26 and discharge lines 27. In this embodiment, nutrient-bearing water from water body 2 is drawn up (shown by intake arrows 40) through inlet pipe 26 by means of pump 25, and then sprinkled across the surface of sandwich island 22 via discharge lines 27. The water percolates through the layers of porous matrix 3 and scrap pieces 23, where nutrients are removed by microbes colonizing the internal surfaces of matrix 3 and scrap pieces 23. The island may be made in any desired thickness by adjusting the thickness of the layers comprising scrap pieces 23 and the layers comprising matrix 3, and by adjusting, the number of alternating layers of scrap pieces 23 and matrix 3.

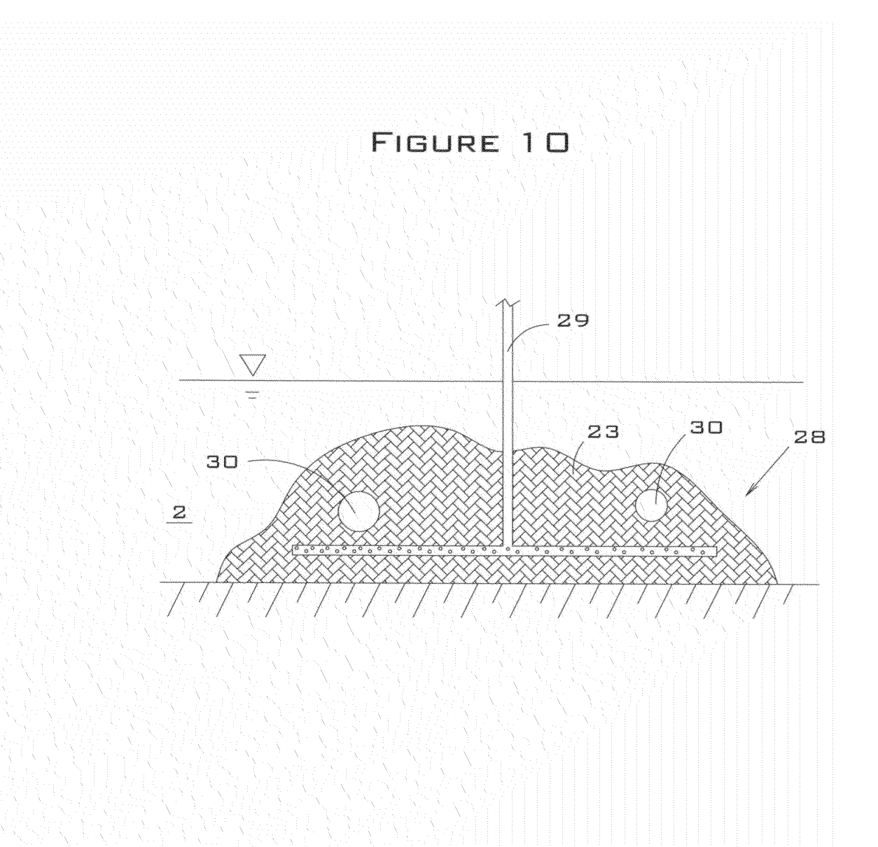

Referring to FIG. 10, simulated coral reef structure 28 is illustrated in accordance with a preferred embodiment of the invention. In this embodiment, simulated coral reef structure 28 is negatively buoyant and rests on the bottom of water body 2. Structure 28 may be used to dissipate wave energy in shallow waters, and may also be used as a water-quality enhancement device. Structure 28 is comprised primarily of scrap polymer pieces 23. Scrap pieces 23 may be bonded together by application of a sprayed-on polyurea or a latex binder (not shown). Scrap pieces 23 may alternately be bonded together by partially melting the pieces 23 with heat. Also shown in FIG. 10 is optional injection system 29. Injection system 29 is used to discharge nutrient-rich water and/or air into the body of the structure 28, thereby promoting growth of colonizing microbes and/or increasing the oxygen supply for Fish and other aquatic animals residing within and around structure 28. Injection system 29 is supplied with water and/or air from an external pump (not shown). Optional cavities 30 are also shown. Cavities 30 may be used as resting, feeding, or hiding areas for fish and other animals. Alternately, cavities 30 may be used to insert stones or other heavy objects, thereby increasing the negative buoyancy of structure 28. Structure 28 may optionally comprise bags of dry cement (not shown) that absorb water and cure in place after structure 28 is deployed, thereby adding negative buoyancy. Structure 28 may optionally be used as an anchor for floating islands or other floating objects (not shown).

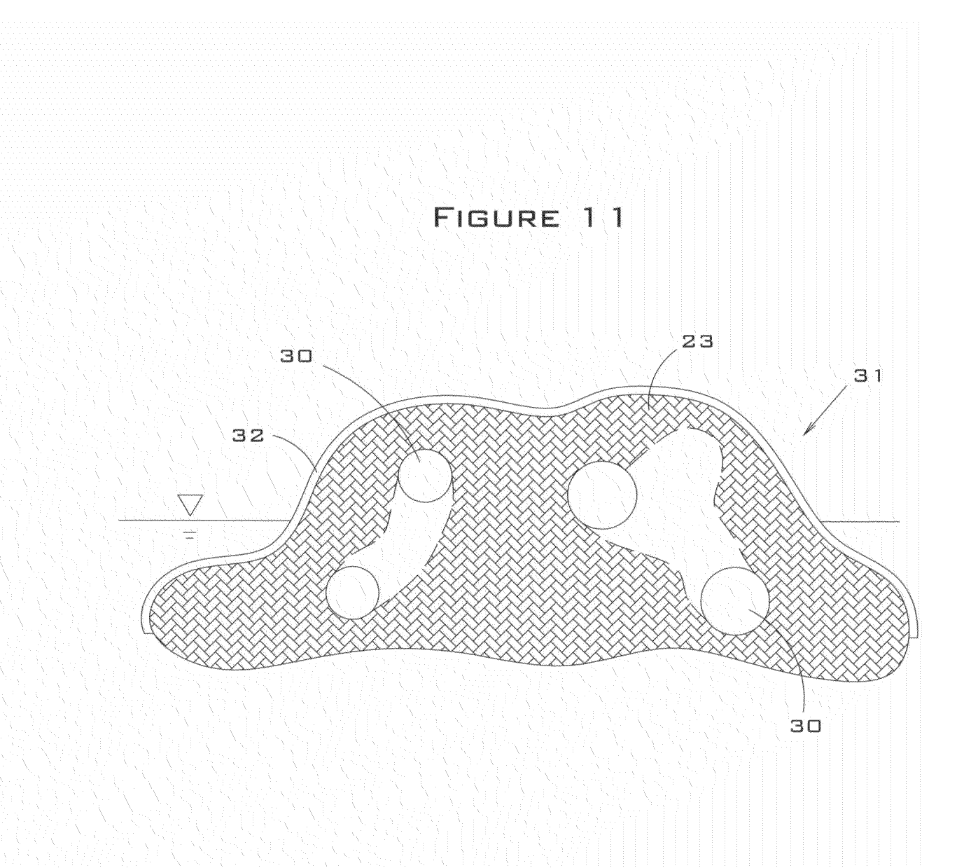

Referring to FIG. 11, a polymer scrap structure 31 is illustrated in accordance with another preferred embodiment of the invention. This embodiment is comprised of scrap polymer pieces 23 that are bonded together with sprayed-on polyurea or polyurethane. Buoyancy may be provided by scrap polymer pieces 23, if the polymer used has a density less than that of water. Additional optional buoyancy may be supplied by polyurethane or thermoplastic foam (not shown). The optional polymer foam may be either injected and cured in place, or it may be provided by preformed foam pieces that are inserted into the body of polymer scrap structure 31 during manufacture. Optionally, scrap pieces of polymer foam may be mixed with scrap pieces of polymer chips to provide the necessary characteristics of permeability, concentrated surface area and buoyancy. Another optional source of buoyancy is gasses that are trapped within the body of structure 31. These gasses may be injected into the island by aeration, or alternately, they may be produced by microbes that colonize the interior or the island body. Optional impermeable top coat 32 may be installed on the outer surface of the island to enhance the gas-trapping abilities of structure 31. Gas-impermeable top coat 32 may be comprised of polyurea or polyurethane. Structure 31 may also have cavities 30 that have openings either above or below waterline (or both), and may be used as habitat for waterfowl, fish, or other aquatic animals.

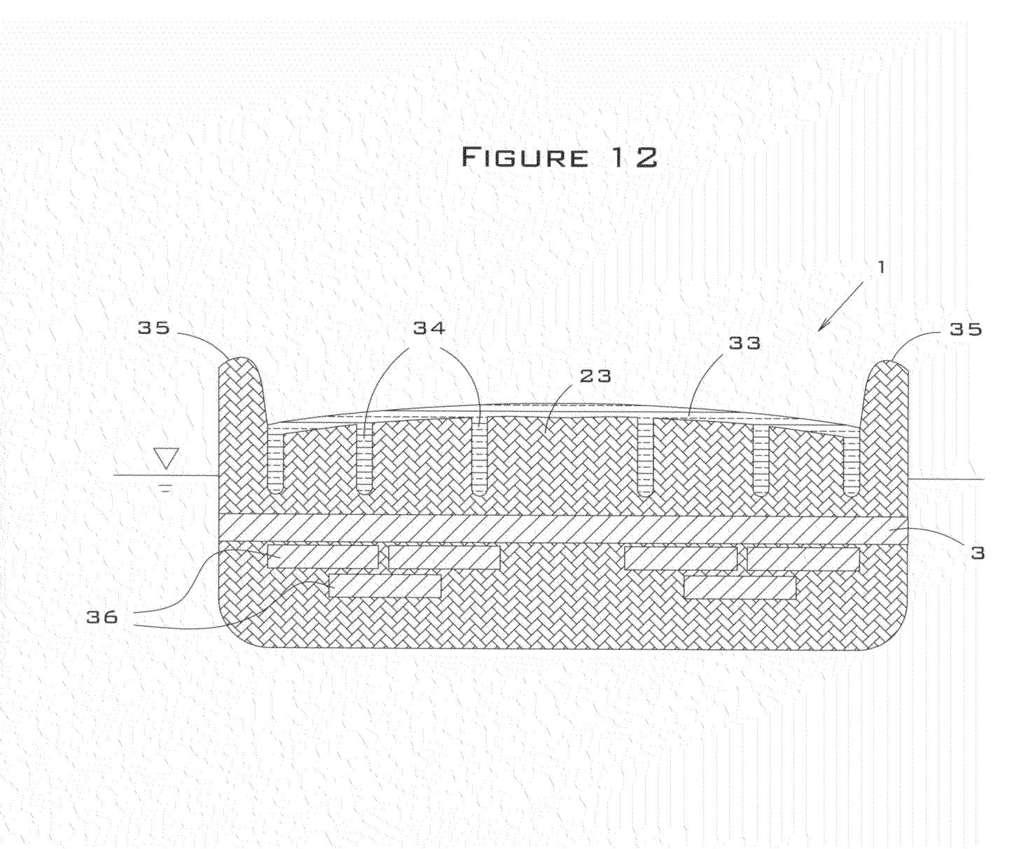

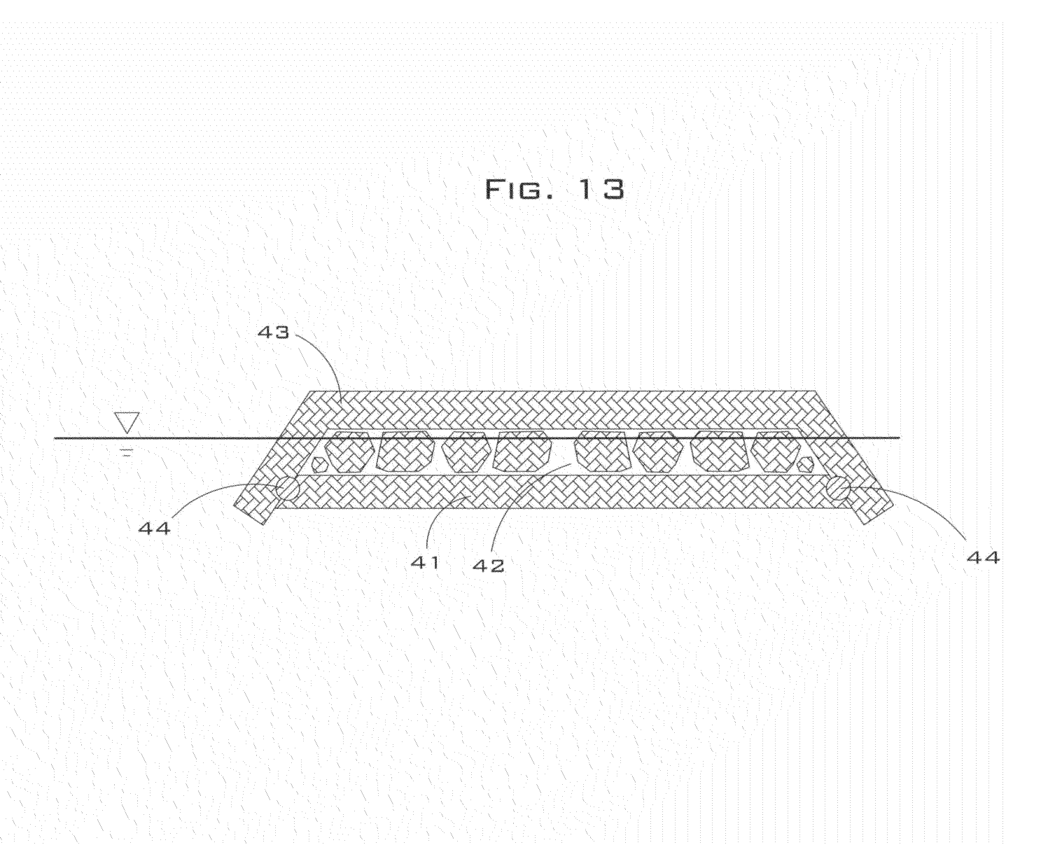

Referring to FIG. 12, another preferred embodiment of floating island 1 is illustrated that comprises a sheet of nonwoven matrix 3, scrap polymer pieces 23 that are bonded to both top and bottom sides of matrix 3, growth medium 33 and capillary tubes 34. Scrap polymer pieces 23 may be bonded together with polyurea or polyurethane. Growth medium 33 may be comprised of BIOMIX™, which is available from Floating Island International, Inc. of Shepherd, Mont., or any other suitable hydrophilic plant growth material. Capillary tubes 34 are preferably filled with hydrophilic growth medium and provide water to growth medium 33 that preferably covers the top surface of floating island 1. Growth medium 33 may be applied to buoyant structure 1 by spraying and curing in place. Perimeter lip 35 helps prevent loss of growth medium 33 due to wave and wind action. Optional matrix scrap pieces 36 may be manufactured into the body of floating island 1 to provide additional surface area for microbial colonization.

In another embodiment shown in FIG. 13, the invention is a floating island that comprises a single bottom layer 41 that is comprised of nonwoven matrix, a middle portion 42 that is comprised of scrap nonwoven matrix or another polymer material and a top blanket 43 of sod, sod-impregnated jute or sod-impregnated polymer blanket. The volume and relative buoyancy of said nonwoven matrix or other polymer material, which may be made of polyester and a polymer other than polyester, determines the volume, if any, of polyurethane foam 44 needed to provide initial buoyancy.

The single layer of nonwoven matrix that comprises bottom layer 41 of this embodiment may be coir, jute, or any polymer, of any thickness. A thinner blanket material is preferred because it is less costly. Middle portion 42 of the floating island, which is made up of scrap matrix or polymer, may have any thickness. Since scrap is less expensive than other materials, this portion of the island is likely to be the thickest portion. Top blanket 43 of the floating island preferably overhangs middle portion 42 and ties into bottom layer 41, providing a sandwich effect that contains the scrap material making up middle portion 42 of the floating island. Polyurethane foam 44 can provide additional buoyancy if needed, as well as an additional means by which to bond all three layers 41, 42 and 43 together.

By cutting scrap polymer into long, thin, jagged strips, and then compressing these strips, the surface area available for microbial colonization can be optimized. These tangled strips are another inexpensive form of matrix blanket. By manipulating the degree of compression of these strips, one may concurrently optimize for plant root growth and gas passage through the strips. In preferred embodiments, the density of these strips is controlled during production by adding a specific volume of strips per square foot, and providing a specific pressure on a compression table. The middle portion of this embodiment may actually be made of another form of matrix blanket. A background art matrix blanket manufactured by Americo requires coating with latex or polyurea or other type coatings to achieve its integrity, whereas this preferred embodiment does not require such coating, but instead relies upon the long narrow strips and jagged edges to provide integrity.

The following seven embodiments are designed to provide internal and external surface area for the attachment of microbial biofilms and periphyton for the purpose of removing excess nutrients from water and funneling these nutrients efficiently up through the food chain. These embodiments are referred to below as the first through seventh embodiments.

In a first embodiment, a simulated coral reef is constructed from a buoyant polymer matrix structure that is anchored at or near the bottom of a water body. This embodiment may be advantageous for locations in which floating water-treatment structures are undesirable (for example, in zones of boat traffic). Although the simulated coral reefs may be constructed from either polymer (e.g., polyester, polyethylene, or polypropylene) or natural fibers (e.g., coir, jute, or tree branches), polymer materials are generally preferred over natural materials for biofilm substrates in natural water systems because natural fibers provide a source of organic carbon for microbial biofilms that grow on the fibers, and the biofilm communities growing on natural materials tend to be dominated by microbes (such as bacteria) that require organic carbon for metabolism. When these microbes metabolize the organic carbon in the natural fibers, they also uptake dissolved oxygen from the water and discharge carbon dioxide as a waste product. Conversely, polymer materials, being substantially inert, do not supply organic carbon and tend to be dominated by biofilms comprised of algae, which uptake carbon from dissolved carbon dioxide in the water and release oxygen to the water as a waste product. As such, polymer materials generally result in the addition of dissolved oxygen to the water body, which is required by aquatic life forms such as fish, while natural substrates tend to deplete the concentration of dissolved oxygen, which can be harmful or fatal to fish and other aquatic life forms.

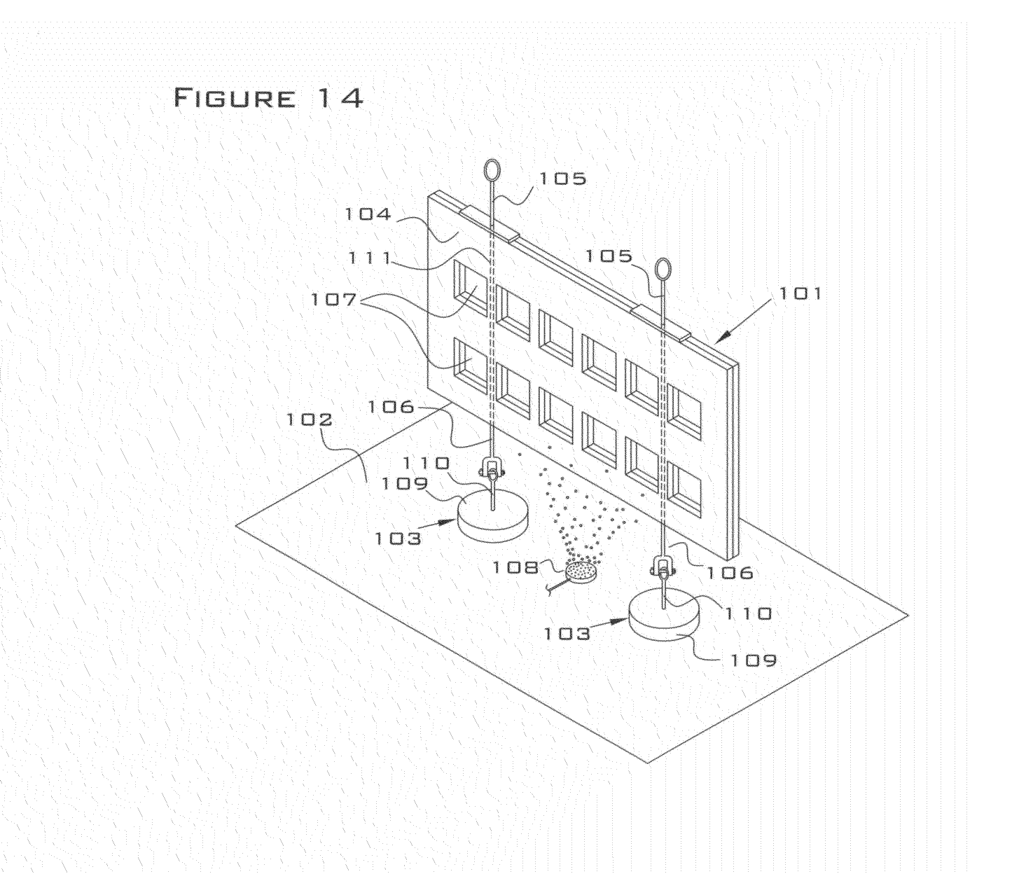

A first embodiment of the invention is shown in FIG. 14. In this embodiment, a buoyant simulated coral structure 101 is suspended above a water body bottom 102. Although the simulated coral structure 101 is buoyant, it is restrained from floating to the surface of the water body by one or more anchor assemblies 103. The key component of the simulated coral structure is the polymer matrix body 104. The polymer matrix body 104 is designed to provide a large internal and external growing surface for biofilms, also known as periphyton. The polymer matrix body 104 is preferably comprised of one or more sheets of permeable and porous nonwoven polymer fiber matting that may optionally be injected with expanding closed-cell polymer foam (not shown). The optional polymer foam provides initial buoyancy to the structure, if needed, and serves to bond multiple layers of matrix together if the matrix body 104 is comprised of multiple layers of matting. The simulated coral structure 101 also comprises deployment connectors 105, anchor connectors 106, optional holes 107, and an optional air bubbler 108 (air supply not shown).

The deployment connectors 105 provide temporary attachment points for ropes, cables, polymer webbing, or chains (not shown) that allow the simulated coral structure 101 to he lowered into position from a boat, dock, or shoreline. These connectors may also be used for connection of floating locator buoys. The deployment connectors 105 shown in FIG. 14 are rods with ring terminals, but other means, such as hooks, shackles, etc., may be alternately utilized.

The anchor connectors 106 provide means for anchors to be attached below the buoyant simulated coral structure. Although the anchor connectors 106 are shown as rods with terminal shackles in FIG. 14, alternate means of anchor connection, such as buckles, cables loops, etc., may be utilized. Lengths of the anchor connectors 106 are selected so as to suspend the buoyant simulated coral structure at a pre-determined distance above the water body bottom 102. For example, in order to provide maximum value for microbial nutrient removal and fish habitat, it may be advantageous to suspend the buoyant simulated coral structure at a distance of ten feet or more above bottom where the bottom water is highly turbid compared to shallower zones; conversely, it may be advantageous to suspend the structure within one foot of the bottom if the bottom water is particularly clear.

The anchor assemblies 103 are preferably comprised of a deadweight 109 and an anchor terminal 110. The deadweight 109 may be comprised of concrete, iron, stones, or other conventional anchor material. The connection joints between the anchor connectors 106 and the anchor terminals 110 are preferably flexible, thereby enabling the anchor assemblies 103 to remain fixed in position on the water body bottom 102 even if the buoyant simulated coral structure 101 oscillates due to water currents.

In preferred methods of construction and deployment, simulated coral structures 101 and the anchor assemblies 103 are manufactured separately, and these two pieces are joined immediately prior to lowering, the assembly into the water body. These methods are advantageous for cost-effective manufacturing and transportation.

Preferably, each deployment connector 105 is made as an integral unit with the anchor connector 106 located beneath it, by means of a connecting rod 111 that passes through the matrix body 104. Suitable materials for the deployment connectors 105, the anchor connectors 106, the anchor terminals 110, and the connecting rods 111 include fiberglass, nylon, high density polyethylene, aluminum, stainless steel, powder coated steel, and galvanized iron. The purpose of the optional holes 107 is to provide increased microbial surface area in contact with the moving water, thereby promoting nutrient uptake, and also to provide additional cover habitat for aquatic animals such as fish.

The optional air bubbler 108 has two purposes. The first purpose of the optional air bubbler 108 is to provide a constant source of oxygen and carbon dioxide to microbes, aquatic macro fauna, and plants that are located near, on, or within the matrix body 104. The second purpose of the optional air bubbler 108 is to create induced water currents that pass alongside and through the permeable matrix body 104, thereby bringing a continuous supply of nutrients to the biofilms.

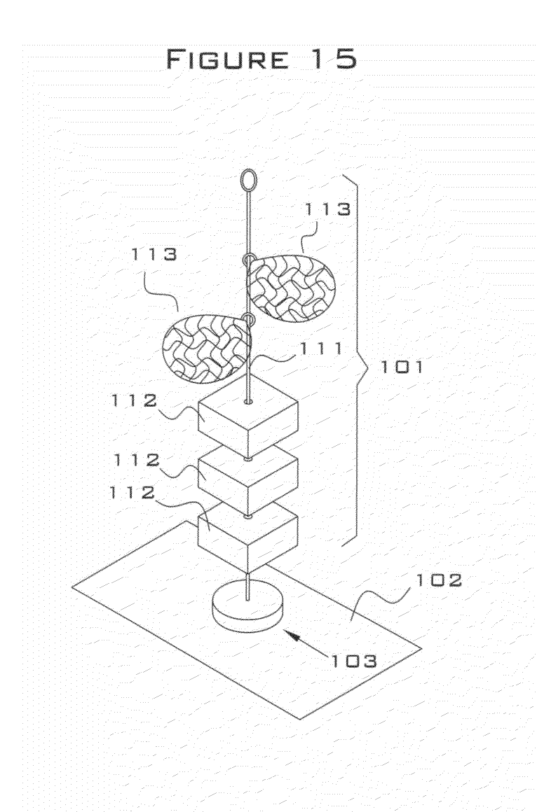

The nonwoven polymer matting comprising the polymer matrix body 104 may alternately be comprised of polyester fibers reinforced with latex binder, recycled carpet fibers bonded into a permeable mat, or scraps of matting or loose fibers that are placed within permeable containment sheets or bags (shown later in FIG. 15). Regardless of the materials used, the matrix body must be sufficiently rigid so that the internal pore spaces between the fibers remain open when exposed to water current forces, thereby maintaining the permeability of the matrix body at all times.

A second embodiment is shown in FIG. 15. In this embodiment, a positively or negatively buoyant simulated coral structure 101 is fabricated from one or more pieces of polymer matrix 112 and/or one or more permeable bag units 113 that are strung together vertically via a connecting rod 111 that passes through each piece of polymer matrix 112 and/or permeable bag unit 113. The lower end of the connecting rod 111 is attached to an anchor assembly 103 that positions the simulated coral structure 101 above the water body bottom 102 at a pre-determined height.

Each piece of polymer matrix 112 may alternately be comprised of polyester fibers reinforced with latex binder or recycled carpet fibers bonded into a permeable mat. Each permeable bag unit 113 is comprised of a containment bag made of netting filled with scrap pieces of polymer matrix, loose polymer fibers, or a combination of scrap matrix and loose fibers. Each of the pieces of polymer matrix 112 and permeable bag units 113 is designed to grow biofilm on the surface areas of the fibers contained within these structures. Each of the pieces of polymer matrix and permeable bag units becomes more buoyant over time as a result of biogases that are produced by the internal biofilms because the biogases adhere to the biofilm-coated surfaces of the internal fibers. Each of the pieces of polymer matrix 112 and permeable bag units 113 may also comprise optional buoyant polymer foam (not shown) in order to provide initial positive buoyancy to these components if desired, or, alternately, they may contain sand, gravel or similar weights to provide initial negative buoyancy. The optional buoyant foam may be uncured thermoset foaming resin or uncured thermoplastic foaming resin that is injected into the matrix/permeable bag for curing or, alternately, preformed pieces of thermoset or thermoplastic foam that are manufactured into the matrix/permeable bag.

Examples of suitable materials for the netting of the permeable bag units 113 include nylon, polyethylene, and polypropylene. One example of a suitable material for the scrap matrix pieces is nonwoven polyester matrix with latex binder. Examples of suitable materials for the loose fibers include polyester fibers or strips manufactured from recycled beverage bottles and recycled carpet fibers from post-consumer scrap carpet.

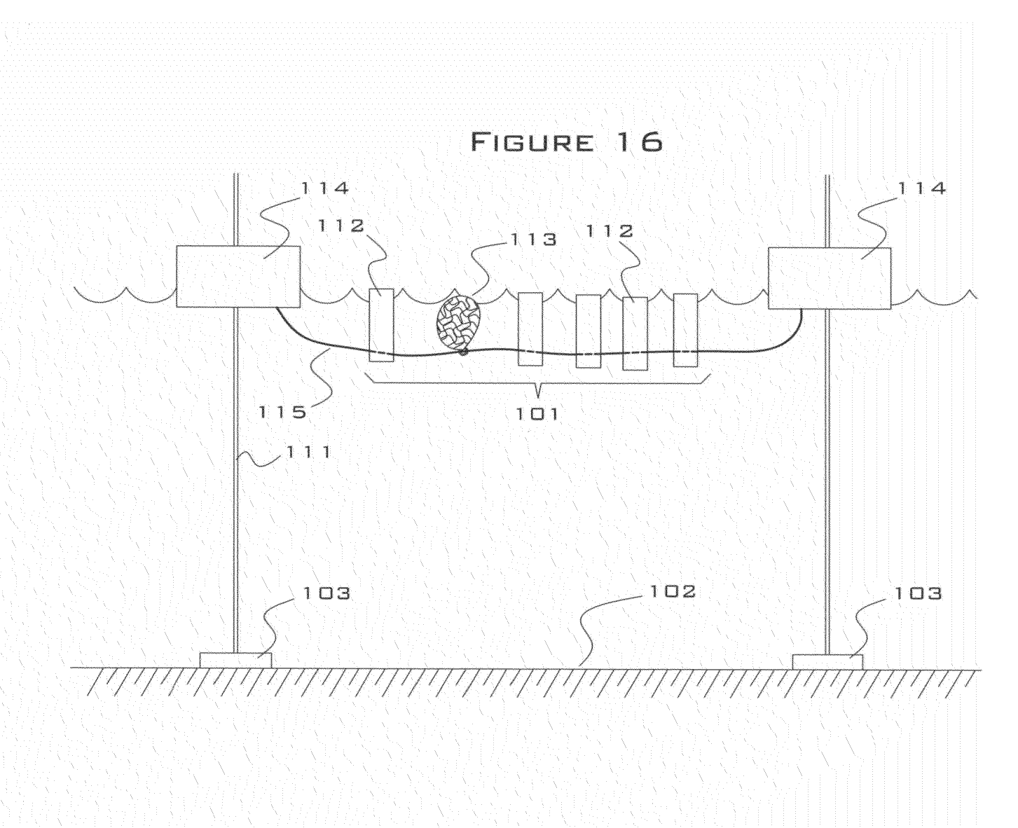

A third embodiment of the present invention is shown in FIG. 16. In this embodiment, a positively or negatively buoyant simulated coral structure 101 is attached to one or more surface attachment structures 114. The surface attachment structures 114 shown in FIG. 16 are floating objects that are anchored to the water body bottom 102 via connecting rods 111. The floating objects may consist of floating islands, buoys, or other similar floating objects. Alternately, the surface attachment structures 114 may consist of docks, shoreline tethers, or other similar structures attached to shore or on pilings. In this embodiment, the positively or negatively buoyant simulated coral structure is comprised of one or more pieces of polymer matrix 112 and/or one or more permeable bag units 113, which are attached to one or more surface attachment structures 114 by a connecting cable 115. As described previously in reference to the second embodiment, optional positive buoyancy for each of the pieces of polymer matrix 112 and/or permeable containment bag units 113 may be provided by optional polymer foam, and optional negative buoyancy may be provided by sand, gravel or similar materials.

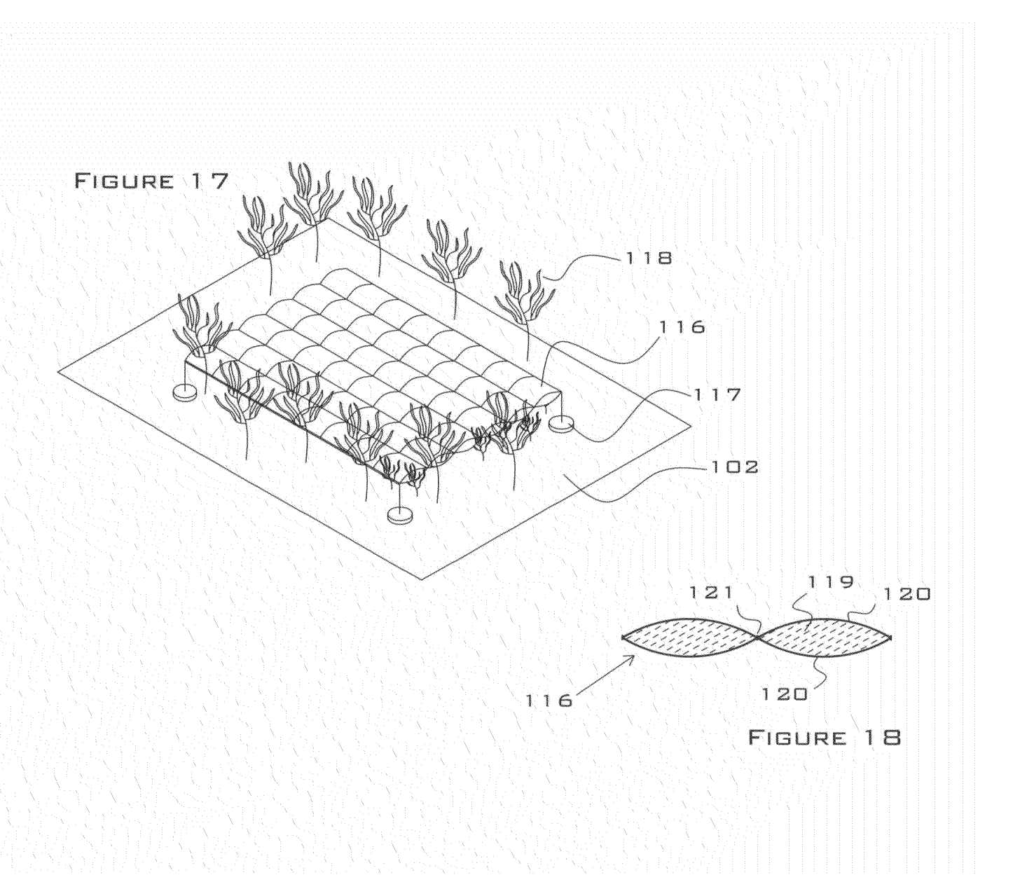

A fourth embodiment of the present invention is shown in FIG. 17. In this embodiment, a weed blanket 116 is suspended above a lake bottom 102 by anchor weights 117 placed around the perimeter of the weed blanket 116. The weed blanket 116 shown in FIG. 17 is comprised of polymer fibers that are sandwiched between two layers of permeable fabric. Alternately, the weed blanket may be comprised of sheets of polymer matrix material (not shown). When the weed blanket 116 is installed over submerged aquatic plants 118, the weed blanket 116 prevents sunlight from reaching the plants 118 that are beneath the weed blanket 116, thereby causing these plants 118 to die and also preventing new plant growth. The weed blanket 116 may optionally be shaped so as to form a long, narrow bottom covering (for example, 15 feet wide by 100 feet long). This shape is particularly advantageous for providing weed-free pathways for boat traffic in lakes with prolific weed growth.

The weed blanket may be designed to be negatively buoyant, neutrally buoyant, or positively buoyant, by the addition of negatively buoyant components such as sand or gravel, or positively buoyant components such as closed cell polymer foam. The anchor weights 117 are designed have sufficient weight in order to maintain the weed blanket 116 in a submerged position even if significant volumes of biogas are trapped within the interior of the weed blanket 116 by microbial activity.

In addition to preventing weed growth, the weed blanket 116 also provides surface area for microbial growth on its interior and exterior surfaces and provides cover and feeding habitat for baitfish and game fish under and/or around the edges of the structure. This embodiment of the present invention is particularly useful for improving the recreational fishing value of a pond by providing a mixture of weed-covered and open areas across the pond bottom, which increases the valuable edge habitat for fish and allows fishermen to cast fishing lures into the weed-free zones.

FIG. 18 is a magnified cross-section view of a portion of the weed blanket 116 shown in FIG. 17. As shown in FIG. 18, polymer fibers 119 are encapsulated between two layers of permeable fabric 120. Polymer thread, plastic ties, polymer webbing, or rope 121 is used to partition the fibers 119 into segmented compartments in order to prevent migration and clumping of the fibers. Examples of materials that are suitable for use as fibers 119 include polyethylene, polyester, and polypropylene. Recycled materials such as post-consumer carpet fibers are a good material for this application. Suitable materials for the permeable fabric 120 include woven polymer carpet backing, nonwoven polymer weed matting, and nonwoven geotextile fabric.

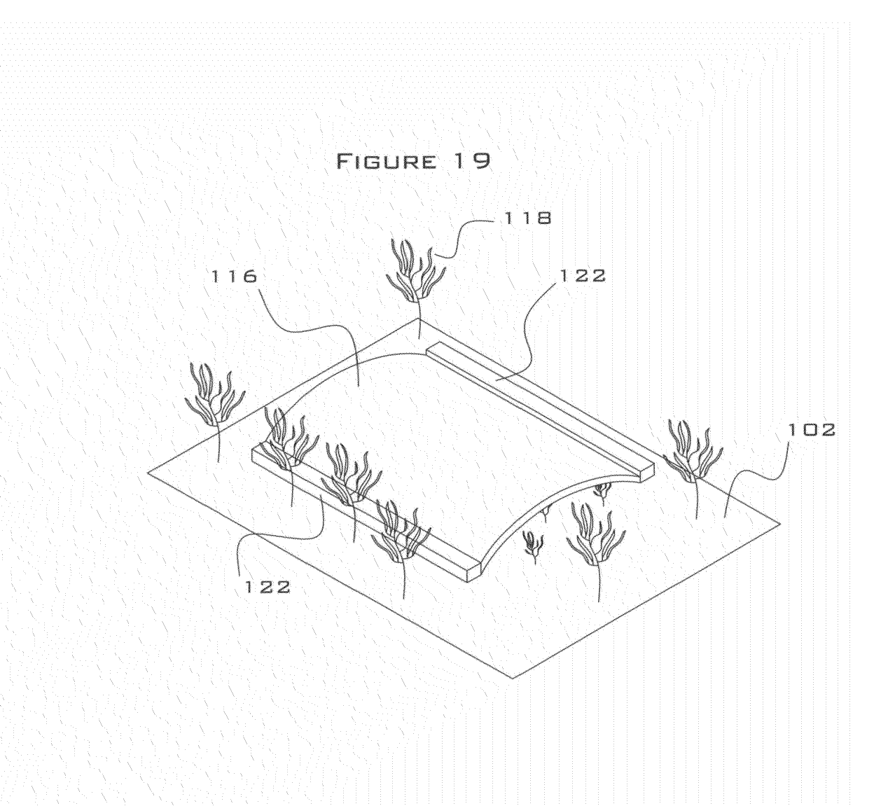

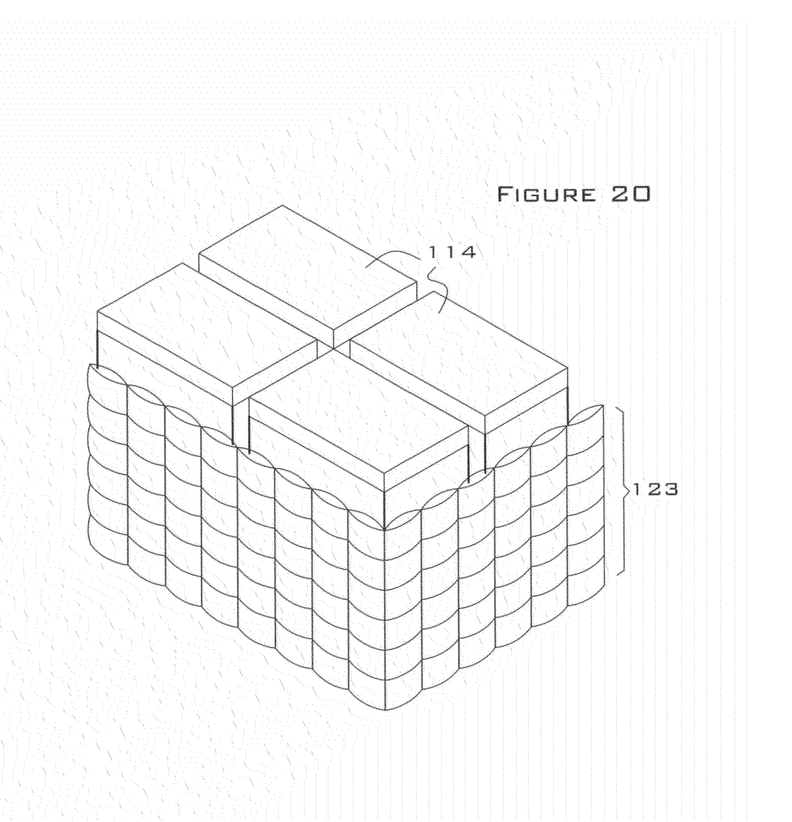

FIG. 19 is a variation of the weed blanket embodiment shown in FIG. 17, in which two edges of the weed blanket 116 are held in contact with the pond bottom by linear anchor weights 122, while the center of the weed blanket 116 is allowed to rise off the pond bottom under its own buoyancy. As shown, this shape provides a tunnel effect on the bottom side of the weed blanket, which is particularly attractive to species of fish that prefer shade and dense cover. The weed blanket 116 shown in FIG. 19 is shown to be comprised of sheets of nonwoven polymer matrix; alternately, this weed blanket could be comprised of polymer fibers sandwiched between layers of permeable fabric, as previously described in reference to FIG. 17.

The weed blankets shown in FIGS. 17 and 19 have the same combined array of benefits, including weed prevention, microbial surface area for nutrient removal, fish cover, and increased sport fishing opportunity. In some lakes, dissolved phosphorus cannot be removed from the water due to insufficient availability of carbon, which is required for microbial metabolism of phosphorus. In these cases, the weed blanket may provide a source of dissolved carbon to the water from decayed plants that are trapped beneath a weed blanket. By this mechanism, the weed blanket may increase the removal efficacy of dissolved phosphorus from the lake. For both variations of the weed blanket embodiment (FIGS. 17 and 19), water is allowed to naturally circulate across both the top and bottom surfaces of the blankets, thereby promoting water circulation to microbial biofilms growing on fibers within the blanket.

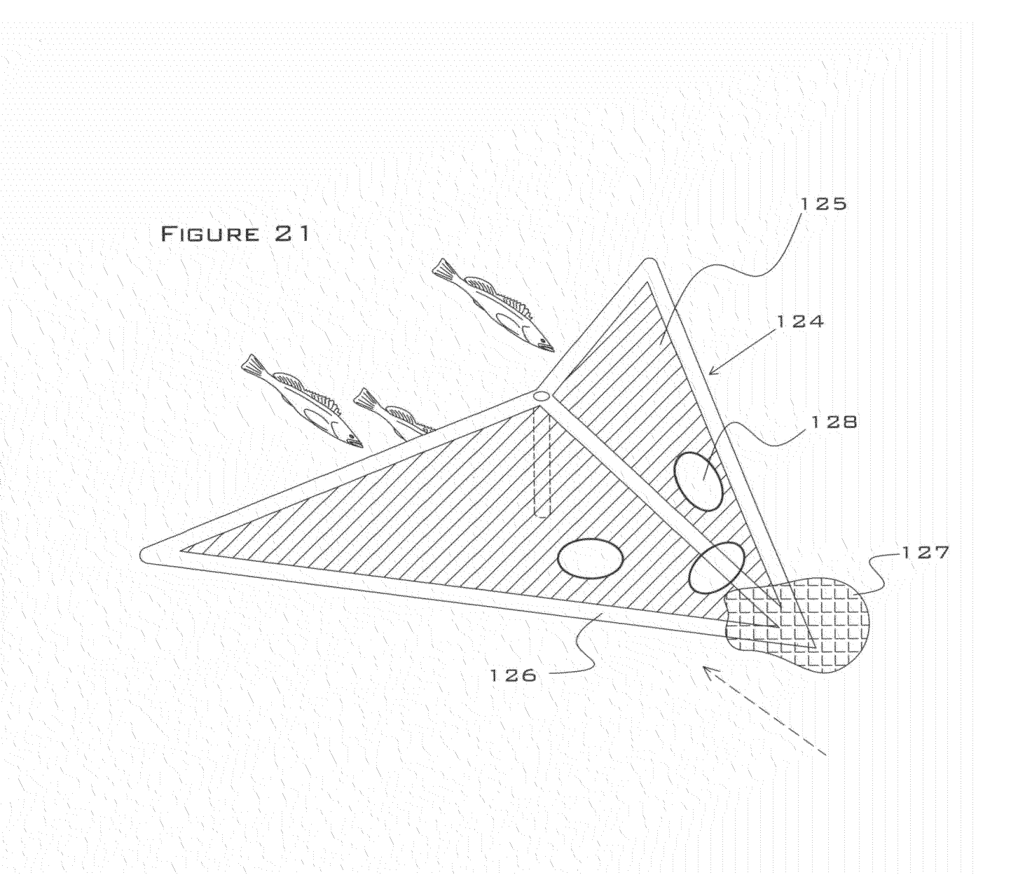

FIG. 20 illustrates a fifth embodiment of the present invention, in which negatively buoyant “hanging curtains” 123 are suspended from surface attachment structures 114. FIG. 7 shows hanging curtains 123 placed around two sides of a floating structure, but the hanging curtains may be placed around all sides of the floating structure and in between the surface attachment structures 114. In this embodiment, the hanging curtains 123 are preferably comprised of polymer fibers that are sandwiched between two sheets of permeable fabric with quilted partitions, as was previously described in reference to FIGS. 17 and 19. Alternately, the hanging curtains 123 may be comprised of sheets of nonwoven polymer matrix.

FIG. 21 is a perspective view of a sixth embodiment of the present invention, which has been optimized for use as a fish shelter for placement on the bottom of moving waters such as streams and rivers. This embodiment is referred to as the “frame and matrix fish shelter” 124. This embodiment is comprised of sheets of permeable polymer matrix 125 that are attached to a rigid metal frame 126. The matrix 125 may be attached to the frame 126 by polymer rope, ring clamps, plastic ties, polymer webbing, or adhesive (not shown). The dashed arrow in the drawing illustrates the direction of water movement. The structure slopes upward from front to rear in order to reduce drag and so that the water moving over the structure tends to force the structure toward the stream or river bottom.

Additional anchoring for the structure is supplied by a polymer net bag filled with rocks 127 and placed over the front edge of the structure. The structure is hollow and open at the rear, allowing fish to enter for security cover and protection from heavy flood currents. Cutouts 128 in the matrix sheets provide viewing ports for fish within the structure, and the cutouts also allow some natural fish foods such as insect larva to pass through the structure for the utilization of fish within the structure. The cutouts also allow for emergency egress of fish within the structure if pursued by predators. A portion of the moving water also passes through the permeable matrix sheets 125, where it supplies nutrients for biofilms that are growing on fibers within the matrix.

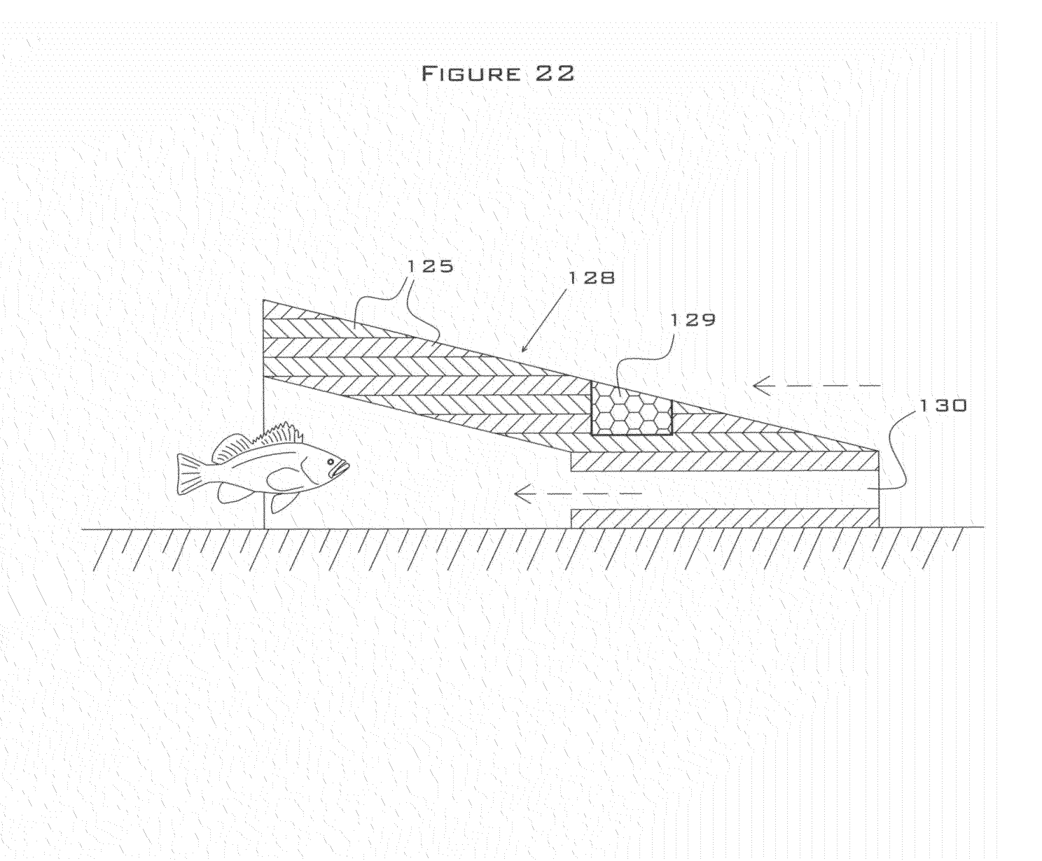

FIG. 22 is a side cross-section view of the seventh embodiment of the present invention, which has also been optimized for use as a fish shelter. The dashed arrows in this drawing depict the direction of water flow. This embodiment is known as the “frameless fish shelter” 128. The frameless fish shelter 128 is comprised of sheets of polymer matrix 125 that are bonded together with foam adhesive. One or more optional rock-filled cavities 129 may be installed as needed to provide sufficient negative buoyancy for the structure depending on water velocity. Optional anchor stakes or weights (not shown) may also be used to help hold the structure in place. One or more passageways 130 are provided through the structure from front to rear, allowing natural fish foods to pass through the structure for the use of fish that are sheltering within the structure. The passageways also allow emergency egress for fish within the structure that are pursued by predators.

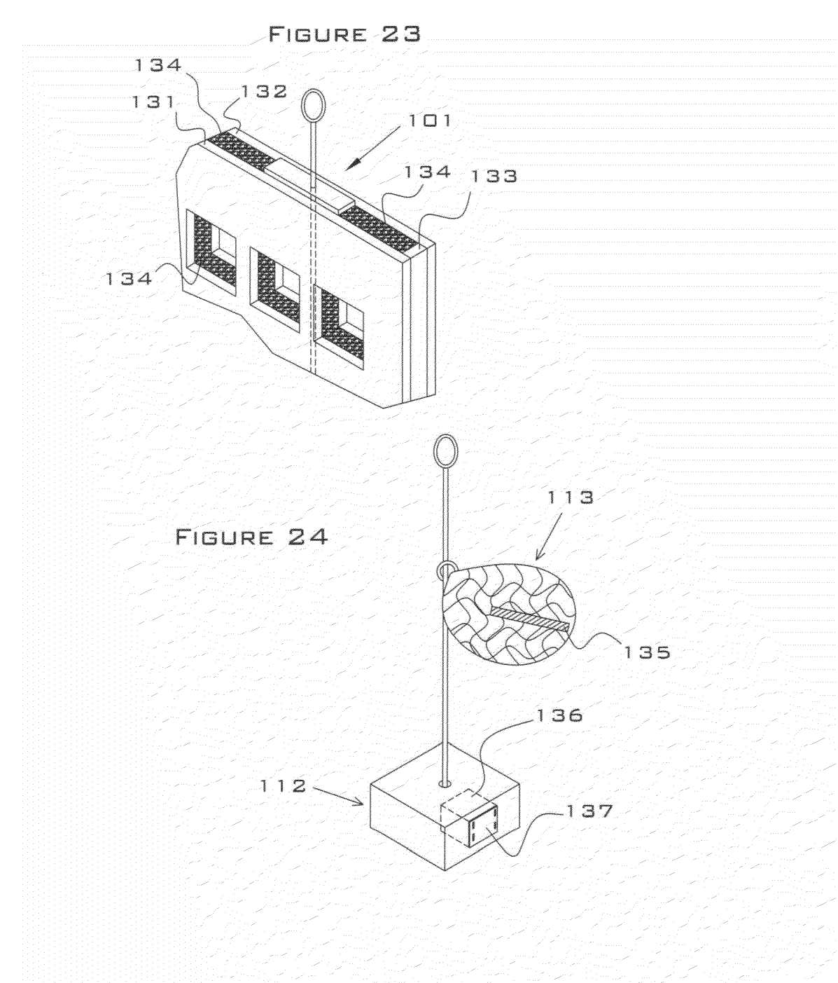

All of the seven embodiments may be optionally modified to provide a means for periodically installing additives into the interior volumes of the structures. These optional features are shown in FIGS. 23 through 26. Optional additives may include organic carbon, nutrients, silica, and/or metals. The purpose of the additives is to boost the metabolic rates of biofilms growing within the structures, thereby increasing the biological removal rates of contaminants from the water bodies in which the structures are located. As an example of using additives to increase biological removal of contaminants, some lakes have high levels of phosphate but low levels of organic carbon and nitrate. Because bacteria require a combination of organic carbon, nitrogen, and phosphate in order to grow, the bacteria cannot utilize the excess phosphate unless supplemental organic carbon and nitrate are added. If the organic carbon and nitrate are added in the proper proportion to the phosphate, the phosphate can be biologically removed from the water along with the added carbon and nitrate. Examples of suitable sources of organic carbon include wood, coir, and jute. An example of a mineral additive is silica, which is required for the growth of beneficial diatoms. An example of a metal additive is iron, which is useful for abiotic removal of phosphate.

FIG. 23 is a detail of the first embodiment shown in FIG. 14 that has been modified to comprise an internal volume for optional additives. As shown in FIG. 23, the modified first embodiment is comprised of a first matrix layer 131, a second matrix layer 132, an edge matrix layer 133, and an internal volume that is filled with supplemental additives 134.

FIG. 24 is a detail of the second embodiment of the present invention that has been modified for the addition of supplemental additives. As shown in the figure, the permeable bag unit 113 has been fitted with a resealable flap opening 135 that provides access to the interior volume of the permeable bag unit 113, for the purpose of installing supplemental additives. The resealable flap opening 135 is preferably sealed by means of a hook-and-loop fastener strip (for example, VELCRO™).

Also shown in FIG. 24 is a piece of polymer matrix 112 that has been modified to accept supplemental additives. The modified piece of polymer matrix 112 comprises a hollow portion 136 that is covered by a reclosable door 137. In this modified second embodiment, supplemental additives are installed into the modified piece of polymer matrix 112 by opening the reclosable door 137, inserting the supplemental additives into the hollow portion 136, and closing the reclosable door 137. The reclosable door 137 is preferably fastened with a strip of hook-and-loop fastener material.

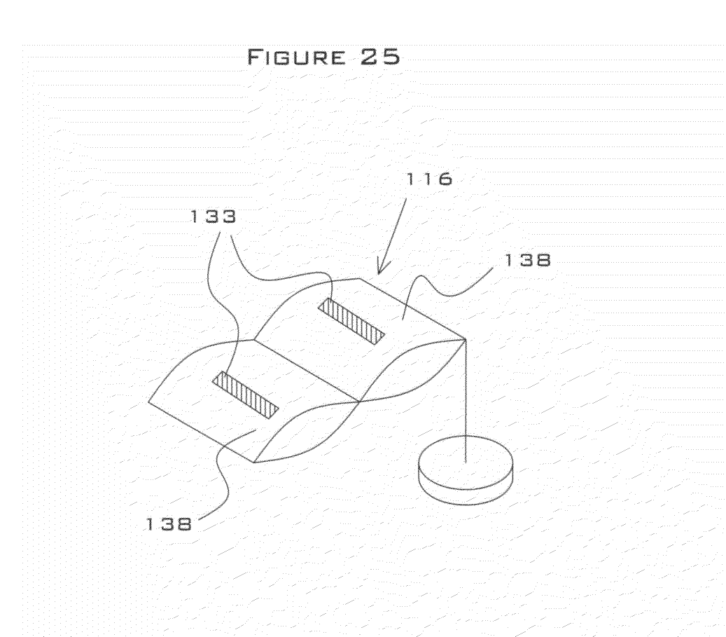

FIG. 25 is a detail of the fourth embodiment of the present invention shown in FIGS. 17 and 18 that has been modified to accept supplemental additives. As shown in the figure, each quilted unit 138 of the weed blanket 116 has been fitted with a resealable flap opening 135, which is similar to the resealable flap opening shown in FIG. 16.

The fifth embodiment of the present invention (hanging curtains) may be optionally modified for the addition of supplemental additives as shown in FIG. 23 (if the hanging curtains are comprised of layers of nonwoven polymer matrix) or as shown in FIG. 25 (if the hanging curtains are comprised of quilted, fiber-filled units.

The sixth and seventh embodiments of the present invention, which are constructed of layers of nonwoven polymer matrix, may be modified for the addition of supplemental additives as shown in FIG. 23.

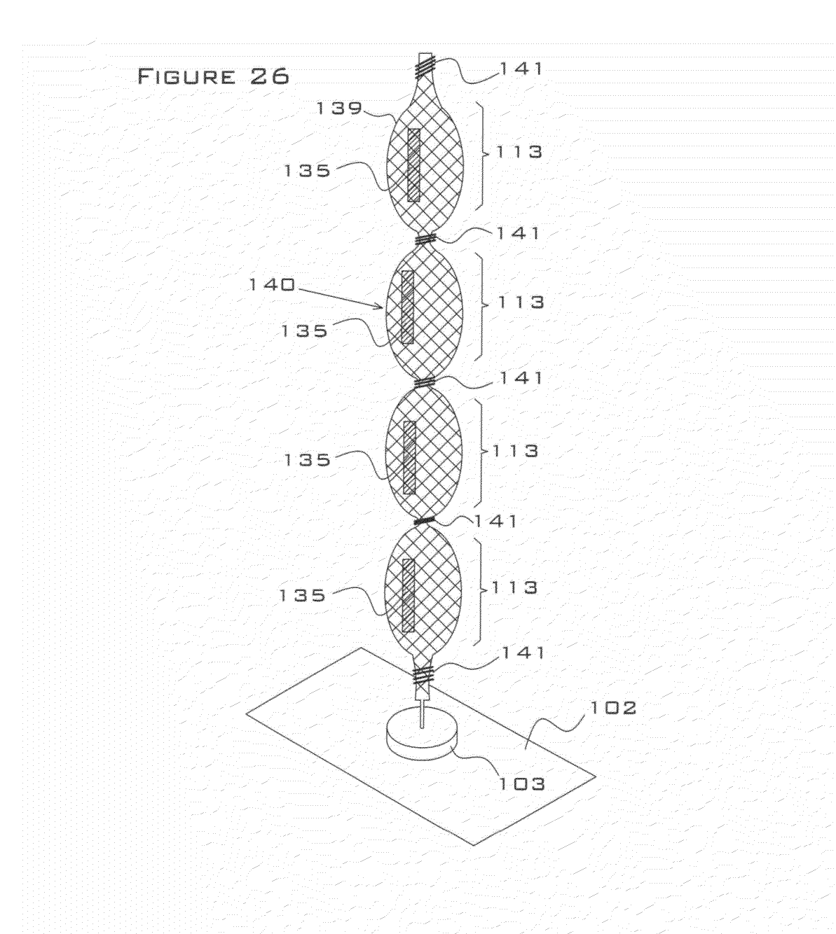

FIG. 26 is a perspective view of a modified form of the second embodiment of the present invention. In this embodiment, multiple permeable bag units 113 are constructed from a single continuous tube of netting 139 that is filled scrap pieces of polymer matrix, loose polymer fibers, or a combination of scrap matrix and loose polymer fibers. This modified embodiment is referred to as the “sausage bag” 140.

Each bag unit 113 of the sausage bag 140 may be optionally fitted with a resealable flap opening 135. The sausage bag 140 is positioned above the lake bottom 102 and held in position with an anchor assembly 103. Polymer rope, plastic ties, polymer webbing and the like 141 may be used to form the individual permeable bag units from the continuous tube of netting 139. The continuous tube of netting 139 is preferably comprised of nylon fish netting.

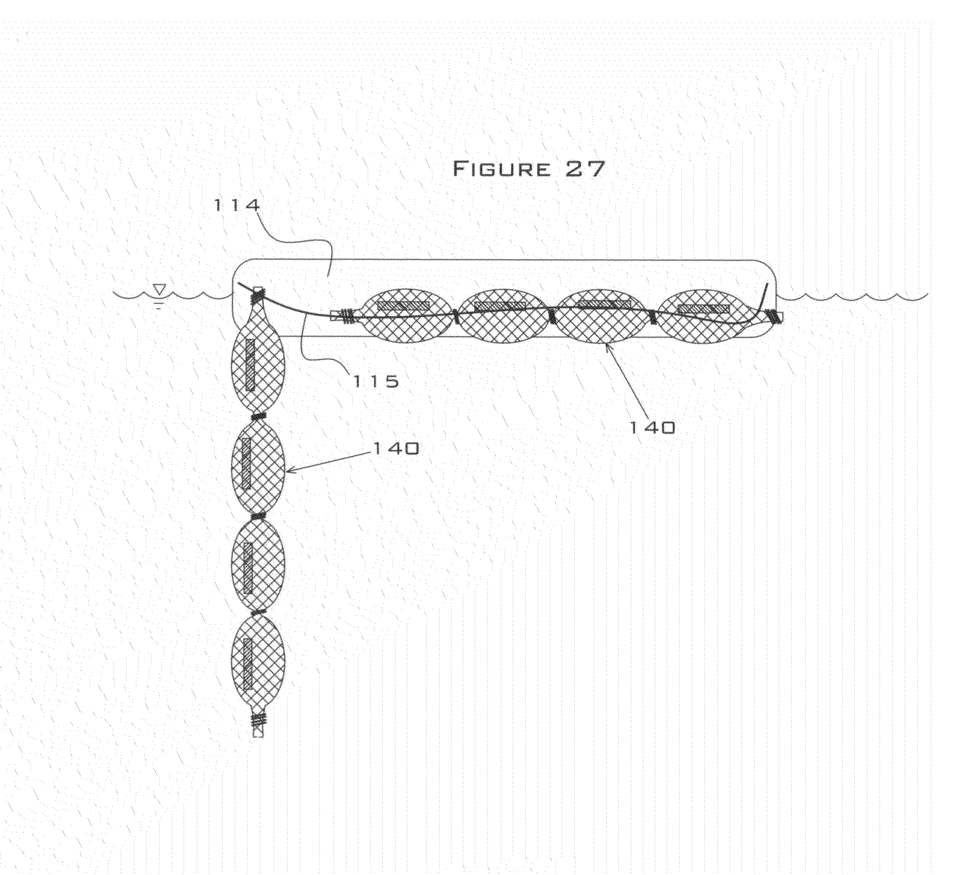

FIG. 27 is a side view of two sausage bag embodiments that are deployed from a floating structure such as a floating treatment wetland, dock, or walkway. As shown in FIG. 27, a sausage bag may be deployed vertically by attaching one end of a negatively buoyant sausage bag 140 to a floating structure 114 and allowing it to hang down into the water. Alternately, as also shown, a sausage bag embodiment may be deployed horizontally by attaching it to a horizontal cable 115 that is connected to a floating structure 114. Deploying the sausage bag embodiments at or near the water surface may be desirable because it provides for maximum exposure of the sausage bags to sunlight, thereby stimulating the growth of algal biofilms on the sausage bags 140. Preferably, this embodiment comprises a negative buoyancy component (such as rock, gravel, cement, metal, or other materials heavier than the water they displace) positioned within at least one of the permeable bag units or attached to the bottom end of the continuous tube of netting.

Many variations of the invention will occur to those skilled in the art. Some variations include providing different cross-section thicknesses at different areas within the structure. Other variations call for providing connecting horizontally- and/or vertically-disposed sections within the structure. All such variations are intended to be within the scope and spirit of the invention.

Although some embodiments are shown to include certain features, the applicants specifically contemplate that any feature disclosed herein may be used together or in combination with any other feature on any embodiment of the invention. It is also contemplated that any feature may be specifically excluded from any embodiment of the invention.

We claim:

1. A simulated coral reef comprising:
(a) a polymer matrix body comprised of one or more sheets of permeable and porous nonwoven polymer fiber matting;
(b) one or more deployment connectors extending outward from the polymer matrix body; and
(c) one or more anchor connectors, each of which connects the matrix body to an anchor assembly.

2. The simulated coral reef of claim 1, wherein each anchor assembly is comprised of a deadweight and an anchor terminal.

3. The simulated coral reef of claim 2, further comprising a flexible connection joint between each anchor connector and anchor terminal.

4. The simulated coral reef of claim 1, wherein the one or more sheets of permeable and porous nonwoven polymer fiber matting are injected with expanding closed-cell polymer foam.

5. The simulated coral reef of claim 1, further comprising at least one connecting rod that passes through the matrix body and connects a deployment connector to an anchor connector.

6. The simulated coral reef of claim 1, wherein the matrix body comprises one or more holes configured to provide increased microbial surface area in contact with moving water and to provide cover habitat for aquatic animals.

7. The simulated coral reef of claim 1, further comprising an air bubbler situated beneath the matrix body.

8. The simulated coral reef of claim 1, wherein the matrix body is comprised of polymer Fibers reinforced with latex binder.

9. The simulated coral reef of claim 1, wherein the matrix body is comprised of recycled carpet fibers bonded into a permeable mat.

10. The simulated coral reef of claim 1, wherein the matrix body comprises internal pore spaces between fibers, and wherein the matrix body is sufficiently rigid so that the internal pore spaces between the fibers remain open when exposed to water current forces.

11. A simulated coral reef comprising one or more pieces of polymer matrix, wherein the one or more pieces of polymer matrix are strung together vertically by a connecting rod that passes through the one or more pieces of polymer matrix; and wherein the connecting rod comprises a lower end, and the lower end of the connecting rod is attached to an anchor assembly.

12. A simulated coral reef comprising one or more permeable bag units, wherein the one or more permeable bag units are strung together vertically by a connecting rod that passes through the one or more permeable bag units; and wherein the connecting rod comprises a lower end, and the lower end of the connecting rod is attached to an anchor assembly.

13. A simulated coral reef comprising one or more pieces of polymer matrix and one or more permeable bag units, wherein the one or more pieces of polymer matrix and the one or more permeable bag units are strung together vertically by a connecting rod that passes through the one or more pieces of polymer matrix and the one or more permeable bag units; and wherein the connecting rod comprises a lower end, and the lower end of the connecting rod is attached to an anchor assembly.

14. The simulated coral reef of claim 11, 12 or 13, wherein each piece of polymer matrix is comprised of polyester fibers reinforced with latex binder.

15. The simulated coral reef of claim 11, 12 or 13, wherein each piece of polymer matrix is comprised of recycled carpet fibers bonded into a permeable mat.

16. The simulated coral reef of claim 11, 12 or 13, wherein each permeable bag unit is comprised of a containment bag made of netting filled with scrap pieces of polymer matrix.

17. The simulated coral reef of claim 11, 12 or 13, wherein each permeable bag unit is comprised of a containment bag made of netting filled with loose polymer fibers.

18. The simulated coral reef of claim 11, 12 or 13, wherein each permeable bag unit is comprised of a containment bag made of netting filled with a combination of scrap matrix and loose fibers.

19. The simulated coral reef of claim 14 or 15, wherein each piece of polymer matrix is further comprised of buoyant polymer foam.

20. The simulated coral reef of claim 16, 17 or 18, wherein each permeable bag unit is further comprised of buoyant polymer foam.

21. The simulated coral reef of claim 19 or 20, wherein the buoyant polymer foam is uncured thermoset foaming resin.

22. The simulated coral reef of claim 19, wherein the buoyant polymer foam is uncured thermoplastic foaming resin that is injected into the one or more pieces of polymer matrix for curing.

23. The simulated coral reef of claim 20, wherein the buoyant polymer foam is uncured thermoplastic foaming resin that is injected into the one or more permeable bail units for curing.

24. The simulated coral reef of claim 19, wherein the buoyant polymer foam is preformed pieces of thermoset foam that are manufactured into the one or more pieces of polymer matrix.

25. The simulated coral reef of claim 20, wherein the buoyant polymer foam is preformed pieces of thermoset foam that are manufactured into the one or more permeable bag units.

26. The simulated coral reef of claim 14 or 15, wherein the one or more pieces of polymer matrix further comprise a negative buoyancy material.

27. The simulated coral reef of claim 16, 17 or 18, wherein the one or more permeable bag units further comprise a negative buoyancy material.

28. A simulated coral reef comprising:
(a) one or more pieces of polymer matrix;
(b) one or more permeable bag units; and
(c) one or more surface attachment structures;
wherein the one or more pieces of polymer matrix and the one or more permeable bag units are attached to the one or more surface attachment structures by a connecting cable.

29. The simulated coral reef of claim 28, wherein the one or more surface attachment structures are floating objects that are anchored to a water body bottom by a connecting rod.

30. The simulated coral reef of claim 28, wherein the one or more pieces of polymer matrix comprise polymer foam.

31. The simulated coral reef of claim 28, wherein the one or more permeable bag units comprise polymer foam.

32. The simulated coral reef of claim 28, wherein the one or more pieces of polymer matrix comprise a negative buoyancy material.

33. The simulated coral reef of claim 28, wherein the one or more permeable bag units comprise a negative buoyancy material.

34. A simulated coral reef comprising a weed blanket that is fully submersed in a water body with a bottom and suspended over the bottom of the water body.

35. The simulated coral reef of claim 34, wherein the weed blanket is comprised of polymer fibers between two layers of permeable fabric.

36. The simulated coral reef of claim 34, wherein the weed blanket is comprised of sheets of polymer matrix material.

37. The simulated coral reel of claim 34, wherein the weed blanket is positively buoyant.

38. The simulated coral reef of claim 34, wherein the weed blanket is negatively buoyant.

39. The simulated coral reef of claim 34, wherein the weed blanket is neutrally buoyant.

40. The simulated coral reef of claim 34, further comprising anchor weights that are situated on top of the weed blanket.

41. The simulated coral reef of claim 35, wherein the fibers are segmented into compartments to prevent migration and clumping of the fibers.

42. The simulated coral reef of claim 34, wherein the weed blanket has a perimeter, further comprising linear anchor weights that are situated along at least a portion of the perimeter of the weed blanket.

43. A simulated coral reef comprising hanging curtains suspended from at least one surface attachment structure, wherein the hanging curtains are comprised of polymer fibers between sheets of permeable fabric with quilted partitions.

44. A simulated coral reef comprising hanging curtains suspended from at least one surface attachment structure, wherein the hanging curtains are comprised of one or more sheets of nonwoven polymer matrix.

45. A simulated coral reef comprising one or more sheets of permeable polymer matrix attached to a rigid metal frame and situated within a water body with a water direction that moves from front to back of the simulated coral reef.

46. The simulated coral reef of claim 45, wherein the sheets of permeable matrix are sloped upward from front to back of the simulated coral reef.

47. The simulated coral reef of claim 45, further comprising a polymer net bag placed over a front edge of the structure.

48. The simulated coral reef of claim 45, wherein the one or more sheets of permeable polymer matrix comprise one or more viewing ports in the form of cutouts in the matrix.

49. A simulated coral reef comprising two or more sheets of polymer matrix bonded together with foam adhesive and further comprising one or more passageways for allowing fish and fish food to pass through the matrix.

50. The simulated coral reef of claim 49 further comprising one or more rock-filled cavities.

51. The simulated coral reef of claim 49, further comprising one or more anchor stakes.

52. The simulated coral reef of claim 49, further comprising one or more anchor weights.

53. A simulated coral reef comprising a single continuous tube of netting divided into permeable bag units, wherein the single continuous tube of netting is situated above a water bottom body and held in position by an anchor assembly.

54. A simulated coral reef comprising a single continuous tube of netting divided into permeable bag units, wherein the single continuous tube of netting is attached to a floating structure.

55. The simulated coral reef of claim 53 or 54, wherein the permeable bag units are filled with scrap pieces of polymer matrix.

56. The simulated coral reef of claim 53 or 54, wherein the permeable bag units are filled with loose polymer fibers.

57. The simulated coral reef of claim 53 or 54, wherein the permeable bag units are filled with a combination of scrap pieces of polymer matrix and loose polymer fibers.

58. The simulated coral reef of claim 53 or 54, wherein the tube of netting is comprised of nylon fish netting.

59. The simulated coral reef of claim 53, further comprising a negative buoyancy component positioned within at least one of the permeable bag units.

60. The simulated coral reef of claim 53, further comprising a negative buoyancy component attached to a bottom end of the continuous tube of netting.

61. The simulated coral reef of claim 1, 11, 12, 13, 28, 34, 43, 44, 45, 49, 53 or 54, further comprising an internal volume for containing supplemental additives.
